(19) United States
(12) Patent Application Publication
(10) Pub. No.: US 2024/0331897 A1
(43) Pub. Date: Oct. 3, 2024

(54) R-T-B BASED PERMANENT MAGNET

(71) Applicant: TDK Corporation, Tokyo (JP)

(72) Inventor: Lihua LIU, Tokyo (JP)

(73) Assignee: TDK Corporation, Tokyo (JP)

(21) Appl. No.: 18/612,422

(22) Filed: Mar. 21, 2024

(30) Foreign Application Priority Data
Mar. 30, 2023 (JP) 2023-056223
Nov. 29, 2023 (JP) 2023-202002

(51) Int. Cl. H01F 1/057; B22F 3/14; B22F 3/17; B22F 9/00; B22F 9/08; C22C 38/00; C22C 38/06; C22C 38/10

(52) U.S. Cl. CPC H01F 1/0571; B22F 3/14; B22F 3/17; B22F 9/008; B22F 9/082; C22C 38/002; C22C 38/005; C22C 38/06; C22C 38/10; B22F 2009/0824; B22F 2301/355; B22F 2998/10; B22F 2999/00; C22C 2202/02

(57) ABSTRACT

A permanent magnet contains a rare-earth element R, a transition metal element T, and boron. The permanent magnet contains a plurality of main phase grains and a plurality of soft magnetic grains. The plurality of soft magnetic grains contain Fe. A cross-section of the permanent magnet includes a plurality of soft magnetic regions. The cross-section of the permanent magnet is parallel to an easy magnetization axis direction of the permanent magnet. Each of the plurality of soft magnetic regions contains the plurality of soft magnetic grains aligned along a direction orthogonal to the easy magnetization axis direction. The plurality of main phase grains and the plurality of soft magnetic regions are alternately disposed in the easy magnetization axis direction. An average value of width of the plurality of soft magnetic grains in the easy magnetization axis direction ranges from 20 nm to 5 μm.

### CROSS-REFERENCE TO RELATED APPLICATIONS

This application is based upon and claims the benefit of priority from Japanese Patent Application No. 2023-202002, filed on Nov. 29, 2023, and Japanese Patent Application No. 2023-056223, filed on Mar. 30, 2023, the entire contents of which are incorporated herein by reference.

### BACKGROUND

### Field

The present disclosure relates to an R-T-B based permanent magnet.

### Description of the Related Art

In general, main phase grains in an R-T-B based permanent magnet are strongly and magnetically coupled to adjacent main phase grains. Accordingly, in order to improve a coercivity of the R-T-B based permanent magnet, it is necessary to form a grain boundary phase enriched with Nd (a pinning site that hinders magnetization reversal) between main phase grains by a design of a composition in which a grain boundary is easily formed, a grain boundary diffusion process, or the like. However, since the grain boundary phase is a non-magnetic phase, a residual magnetic flux density of the R-T-B based permanent magnet decreases due to formation of a large amount of grain boundary phases.

A permanent magnet disclosed in Japanese Unexamined Patent Publication No. 2012-234985 aimed at a high coercivity and a high residual magnetic flux density. In the permanent magnet disclosed in Japanese Unexamined Patent Publication No. 2012-234985, a soft magnetic phase (α-Fe phase or the like) exhibiting higher saturation magnetization Ms as compared with a main phase (a hard magnetic phase). In a method of manufacturing the magnet disclosed in Japanese Unexamined Patent Publication No. 2012-234985, a ribbon is formed by rapidly cooling a molten metal containing a large amount of Fe as compared with a stoichiometric composition of Nd₂Fe₁₄B. The permanent magnet disclosed in Japanese Unexamined Patent Publication No. 2012-234985 is obtained by sintering the ribbon containing a large amount of Fe. Permanent magnets disclosed in Japanese Unexamined Patent Publication No. 2012-234985, Japanese Unexamined Patent Publication No. 2005-93730, and the following scientific publication by Gabay et al. have a metastable structure formed from aggregates of fine crystals in which a soft magnetic phase containing Fe and a hard magnetic phase containing Nd₂Fe₁₄B coexist. This structure is referred to as a “nano composite magnet” or “exchange spring magnet”. (see A. M. Gabay et al., Numerical simulation of a magnetostatically coupled composite magnet, JOURNAL OF APPLIED PHYSICS 101, 09K 507 (2007).)

### SUMMARY

An objective of an aspect of the present disclosure is to provide an R-T-B based permanent magnet in which a high residual magnetic flux density and a high coercivity are compatible with each other.

For example, as in the following [1] to [6], the aspect of the present disclosure relates to an R-T-B based permanent magnet.

[1] An R-T-B based permanent magnet, containing:
a rare-earth element R;
a transition metal element T; and
boron (B),
wherein the R-T-B based permanent magnet contains at least Nd as the rare-earth element R,
the R-T-B based permanent magnet contains at least Fe as the transition metal element T,
the R-T-B based permanent magnet contains a plurality of main phase grains and a plurality of soft magnetic grains,
the plurality of main phase grains contain at least the rare-earth element R, the transition metal element T, and boron,
the plurality of soft magnetic grains contain at least Fe,
a cross-section of the R-T-B based permanent magnet includes a plurality of soft magnetic regions,
the cross-section of the R-T-B based permanent magnet is parallel to an easy magnetization axis direction of the R-T-B based permanent magnet,
each of the plurality of soft magnetic regions contains the plurality of soft magnetic grains aligned along a direction orthogonal to the easy magnetization axis direction,
the plurality of main phase grains and the plurality of soft magnetic regions are alternately disposed in the easy magnetization axis direction, and
an average value of width of the plurality of soft magnetic grains in the easy magnetization axis direction ranges from 20 nm to 5 μm.

[2] The R-T-B based permanent magnet according to [1],
wherein an average value of intervals of the plurality of soft magnetic regions in the easy magnetization axis direction ranges from 4 μm to 15 μm.

[3] The R-T-B based permanent magnet according to [1] or [2],
wherein an area fraction of the plurality of soft magnetic grains in the cross-section of the R-T-B based permanent magnet ranges from 4% to 15%.

[4] The R-T-B based permanent magnet according to any one of [1] to [3],
wherein at least a part of the plurality of soft magnetic grains contains an R-T phase containing the rare-earth element R and the transition metal element T.

[5] The R-T-B based permanent magnet according to any one of [1] to [4],
wherein a content of the rare-earth element R ranges from 26% by mass to 32% by mass, and a content of boron ranges from 0.77% by mass to 1.15% by mass.

[6] The R-T-B based permanent magnet according to any one of [1] to [5],
wherein the plurality of main phase grains observed in the cross-section of the R-T-B based permanent magnet have platelet shapes.

[7] The R-T-B based permanent magnet according to any one of [1] to [6],
wherein widths of the plurality of main phase grains in the easy magnetization axis direction are smaller than widths of the plurality of the main phase grains in a direction orthogonal to the easy magnetization axis direction, and
an average value of the width of the plurality of main phase grains in the easy magnetization axis direction ranges from 20 nm to 200 nm.

According to the aspect of the present disclosure, an R-T-B based permanent magnet in which a high residual magnetic flux density and a high coercivity are compatible is provided.

### BRIEF DESCRIPTION OF THE DRAWINGS

FIG. 1A is a schematic perspective view of an R-T-B based permanent magnet according to an embodiment of the present disclosure,

FIG. 1B is a schematic view of a cross-section of the R-T-B based permanent magnet (an arrow view along a line b-b direction in the R-T-B based permanent magnet), and a cross-section shown in FIG. 1B is parallel to an easy magnetization axis direction of the R-T-B based permanent magnet.

FIG. 2 is an enlarged view of a part (region II) of the cross-section shown in FIG. 1B.

FIG. 3A is a back scattered electron image of the cross-section of the R-T-B based permanent magnet of Example 1, a cross-section shown in FIG. 3A is parallel to the easy magnetization axis direction of the R-T-B based permanent magnet, and FIG. 3B is a back scattered electron image taken at a high magnification on the cross-section shown in FIG. 3A.

FIG. 4A is a back scattered electron image of a cross-section of an R-T-B based permanent magnet of Comparative Example 5, a cross-section of the R-T-B based permanent magnet shown in FIG. 4A is parallel to an easy magnetization axis direction of the R-T-B based permanent magnet, and FIG. 4B is a back scattered electron image taken at a high magnification on the cross-section shown in FIG. 4A.

FIG. 5A is a back scattered electron image that is identical with FIG. 3A, a cross-section shown in FIG. 5A is parallel to the easy magnetization axis direction of the R-T-B based permanent magnet, FIG. 5B is an image obtained by image processing of the back scattered electron image shown in FIG. 5A, FIG. 5C is an image obtained by image processing of the image shown in FIG. 5B, and FIG. 5A, FIG. 5B, and FIG. 5C show the identical cross-section.

FIG. 6A is an image that is identical with FIG. 5B, a cross-section shown in FIG. 6A is parallel to the easy magnetization axis direction of the R-T-B based permanent magnet, and FIG. 6B is a graph showing positions of a plurality of soft magnetic grains arranged in the easy magnetization axis direction at a measurement region a1 shown in FIG. 6A.

FIG. 7A is an image that is identical with FIG. 5B, a cross-section shown in FIG. 7A is parallel to the easy magnetization axis direction of the R-T-B based permanent magnet, and FIG. 7B is a graph showing positions of a plurality of soft magnetic grains arranged in the easy magnetization axis direction at a measurement region a2 shown in FIG. 7A.

FIG. 8A is an image that is identical with FIG. 5B, a cross-section shown in FIG. 8A is parallel to the easy magnetization axis direction of the R-T-B based permanent magnet, and FIG. 8B is a graph showing positions of a plurality of soft magnetic grains arranged in the easy magnetization axis direction at a measurement region a3 shown in FIG. 8A.

FIG. 9A is an image that is identical with FIG. 5B, a cross-section shown in FIG. 9A is parallel to the easy magnetization axis direction of the R-T-B based permanent magnet, and FIG. 9B is a graph showing positions of a plurality of soft magnetic grains arranged in the easy magnetization axis direction at a measurement region a4 shown in FIG. 9A.

### DETAILED DESCRIPTION

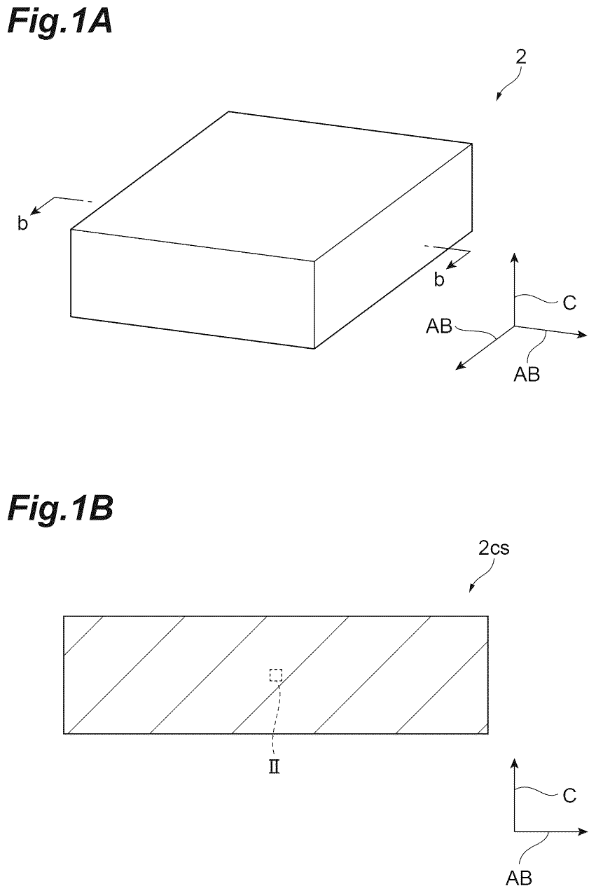

Hereinafter, preferred embodiments of the present disclosure will be described with reference to the accompanying drawings. In the drawings, an equivalent reference numeral will be given to an equivalent constituent element. The present disclosure is not limited to the following embodiments. An arrow C and two arrows AB shown in FIGS. 1A and 1B show three coordinate axes orthogonal to each other. An arrow C corresponds to an easy magnetization axis direction C of an

R-T-B based permanent magnet. Each of the two arrows AB corresponds to an AB direction orthogonal to the easy magnetization axis direction C. The easy magnetization axis direction C and the AB direction are common to all drawings. For example, the R-T-B based permanent magnet may be an R-T-B based hot deformed magnet or an

R-T-B based sintered magnet. In the following embodiments, the R-T-B based permanent magnet is noted as “permanent magnet” for simplicity.

### (Permanent Magnet)

The permanent magnet according to this embodiment contains at least a rare-earth element R, a transition metal element T, and boron (B).

The permanent magnet contains at least neodymium (Nd) as the rare-earth element R. The permanent magnet may contain another rare-earth element R in addition to Nd. The other rare-earth element R contained in the permanent magnet may be at least one element selected from the group consisting of scandium (Sc), yttrium (Y), lanthanum (La), cerium (Ce), praseodymium (Pr), promethium (Pm), samarium (Sm), europium (Eu), gadolinium (Gd), terbium (Tb), dysprosium (Dy), holmium (Ho), erbium (Er), thulium (Tm), ytterbium (Yb), and lutetium (Lu). The permanent magnet 2 does not have to contain heavy rare-earth elements (for example, both Dy and Tb).

The permanent magnet contains at least iron (Fe) as the transition metal element T. The permanent magnet may contain only Fe as the transition metal element T. The permanent magnet may contain both Fe and cobalt (Co) as the transition metal element T.

FIG. 1A is a perspective view of the permanent magnet 2 according to this embodiment, and FIG. 1B is a schematic view of a cross-section 2cs of the permanent magnet 2. The cross-section 2cs of the permanent magnet 2 is approximately parallel or completely parallel to the easy magnetization axis direction C of the permanent magnet 2. The easy magnetization axis direction C is a direction parallel to a straight line connecting a pair of magnetic poles of the permanent magnet 2. That is, the easy magnetization axis direction C is a direction from an S pole of the permanent magnet 2 towards an N pole of the permanent magnet 2. The easy magnetization axis direction C may be specified on the basis of measurement of a magnetic flux distribution of the permanent magnet 2. The easy magnetization axis direction C may be specified on the basis of measurement of a magnetic flux distribution of an analysis sample separated from the permanent magnet 2. As described above, the AB direction is orthogonal to the easy magnetization axis direction C.

The permanent magnet 2 according to this embodiment is a rectangular parallelepiped (plate). However, a shape of the permanent magnet 2 is not limited to the rectangular parallelepiped. For example, the shape of the permanent magnet 2 may be a cube, a polygonal prism, an arc segment, an annular sector, a sphere, a disk, a cylinder, a tube, or a ring. For example, the shape of the cross-section 2cs of the permanent magnet 2 may be a polygon, a circular arc (circular chord), a bow, an arch, a C-shape, or a circle.

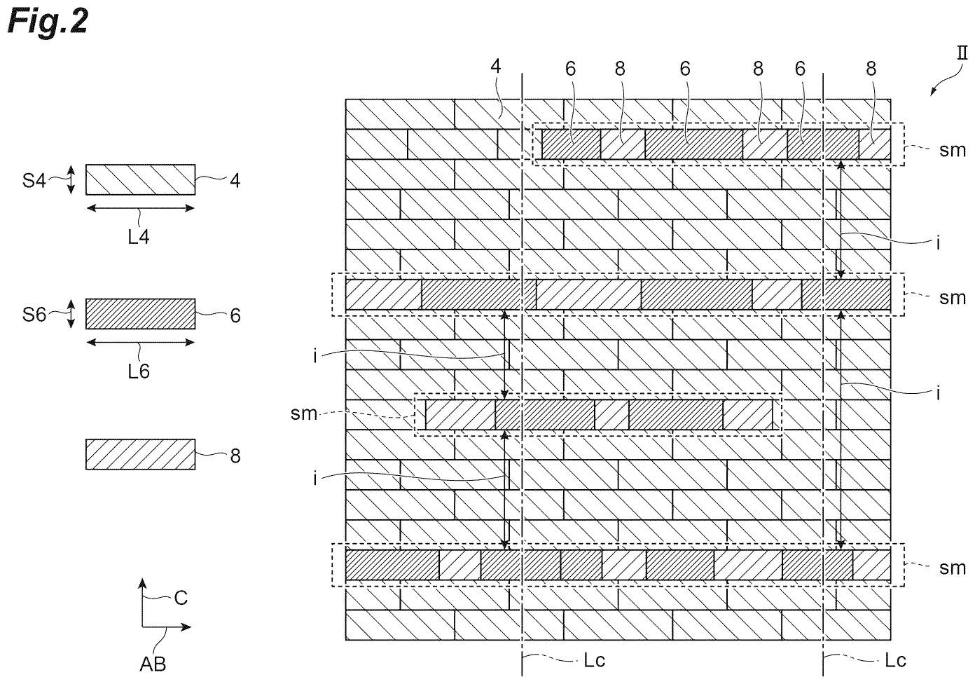

FIG. 2 is an enlarged view of a part (region II) of the cross-section 2cs shown in FIG. 1B. As illustrated in FIG. 2, the permanent magnet 2 contains a plurality of main phase grains 4, and a plurality of soft magnetic grains 6. The plurality of main phase grains 4 are hard magnetic materials. The permanent magnet 2 may further contain a plurality of sub-phase grains 8.

The plurality of main phase grains 4 contain at least the rare-earth element R, the transition metal element T, and B. The main phase grain 4 contains at least Nd as the rare-earth element R. The main phase grain 4 contains at least Fe as the transition metal element T. The main phase grain 4 may be referred to as a crystal grain (that is, a primary grain). The main phase grain 4 contains a crystal (a single crystal or a polycrystal) of R₂T₁₄B. R₂T₁₄B is a ternary intermetallic compound that is magnetically hard. The main phase grain 4 may consist only of the crystal of R₂T₁₄B. The crystal of R₂T₁₄B may be tetragonal. That is, crystal axes of R₂T₁₄B are an a-axis, a b-axis, and a c-axis, the a-axis, the b-axis, and the c-axis are orthogonal to each other, a lattice constant of an a-axis direction of R₂T₁₄B may be the same as a lattice constant of a b-axis direction of R₂T₁₄B, and a lattice constant of a c-axis direction of R₂T₁₄B may be different from the lattice constant of each of the a-axis direction and the b-axis direction. The c-axis direction of R₂T₁₄B may be approximately parallel or completely parallel to the easy magnetization axis direction C of the permanent magnet 2.

For example, R₂T₁₄B constituting the main phase grain 4 may be expressed by (Nd₁₋ₓPrₓ)₂(Fe_{1-y}Co_{y})₁₄B. x may be equal to or more than 0 and less than 1. y may be equal to or more than 0 and less than 1. The main phase grain 4 may contain a heavy rare-earth element such as Tb and Dy as R in addition to a light rare-earth element. A part of B in R₂T₁₄B may be substituted with another element such as carbon (C). The composition in the main phase grain 4 may be uniform. The composition in the main phase grain 4 may be non-uniform. For example, a concentration distribution of each of R, T, and B in the main phase grain 4 may have a gradient. The main phase grain 4 may contain another element in addition to R, T, and B. As shown in FIG. 2, the plurality of main phase grains 4 observed in the cross-section 2cs parallel to the easy magnetization axis direction C may have platelet shapes. In other words, the main phase grains 4 observed in the cross-section 2cs may have a plate shape. The plurality of platelet-shaped main phase grains 4 may be stacked along the easy magnetization axis direction C. The permanent magnet 2 may further contain a secondary grain composed of the plurality of main phase grains 4 bonded to each other. The permanent magnet 2 may contain a plurality of the secondary grains.

The plurality of soft magnetic grains 6 contains at least Fe. The plurality of soft magnetic grains 6 are ferromagnetic materials. The sum of contents of Fe and Co in the plurality of soft magnetic grains 6 may range from 70% by mass to 100% by mass. When the sum of contents of Fe and Co in the soft magnetic grains 6 is 70% by mass or more, the soft magnetic grains 6 are likely to exhibit ferromagnetism, and a saturation magnetic flux density of the soft magnetic grains 6 is likely to be higher than a saturation magnetic flux density of the main phase grains 4, and a residual magnetic flux density of the soft magnetic grains 6 is also likely to be higher than a residual magnetic flux density of the main phase grains 4. For example, a saturation magnetic flux density Bs of an α-Fe phase is 2.15 T, while a saturation magnetic flux density Bs of Nd₂Fe₁₄B is 1.61 T. The plurality of soft magnetic grains 6 may further contain an element other than Fe. For example, each of the plurality of soft magnetic grains 6 may further contain at least one element among R, B, and Co. For example, at least a part of the plurality of soft magnetic grains 6 may contain at least one selected from the group consisting of the α-Fe phase, an R-T phase, an Fe₃B phase, and an Fe₂Co phase. For example, each of the plurality of soft magnetic grains 6 may contain at least one selected from the group consisting of the α-Fe phase, the R-T phase, the Fe₃B phase, and the Fe₂Co phase. Each of the plurality of soft magnetic grains 6 may consist only of at least one selected from the group consisting of the α-Fe phase, the R-T phase, the Fe₃B phase, and the Fe₂Co phase. As long as the plurality of soft magnetic grains 6 contain Fe, the permanent magnet 2 may contain plural kinds of soft magnetic grains 6 that differ in composition. The compositions of the plurality of soft magnetic grains 6 may be the same as each other. Each of the plurality of soft magnetic grains 6 may be a single crystal or a polycrystal.

The R-T phase contains the rare-earth element R and the transition metal element T. At least a part of T contained in the R-T phase is Fe. The R-T phase may further contain a transition metal element (such as Co or Cu) other than Fe as T. At least a part of R contained in the R-T phase may be Nd. The R-T phase may further contain one or more kinds of different rare-earth elements as R in addition to Nd. The R-T phase may further contain B. A concentration (unit: atomic %) of all of R in one of the soft magnetic grains 6 may be expressed as [R], a concentration (unit: atomic %) of all of T in one of the soft magnetic grains 6 may be expressed as [T], and [T]/[R] of the soft magnetic grain 6 containing the R-T phase may range from 8.4 to 8.8. For example, at least a part of the plurality of soft magnetic grains 6 may contain an R₂T₁₇ phase as the R-T phase. In this case, [T]/[R] of the soft magnetic grain 6 containing the R₂T₁₇ phase may be 8.5. The R-T phase may be crystalline. For example, a crystal structure of the R-T phase may be a Th₂Zn₁₇-type structure, a Th₂Ni₁₇-type structure, or a TbCu₇-type structure. The crystal structure of the R-T phase may be identified by a scanning transmission electron microscope (STEM).

The cross-section 2cs parallel to the easy magnetization axis direction C contains a plurality of soft magnetic regions sm. Each of the plurality of soft magnetic regions sm contains a plurality of soft magnetic grains 6 aligned along a direction (AB direction) that is approximately orthogonal or completely orthogonal to the easy magnetization axis direction C. An angle between the easy magnetization axis direction C and the direction along which the plurality of soft magnetic grains 6 in each of the plurality of soft magnetic regions sm are aligned may be more than 45° and equal to or less than 90°, and preferably 90°. Each of the plurality of soft magnetic regions sm may consist only of the plurality of soft magnetic grains 6. The soft magnetic grains 6 adjacent to each other in the soft magnetic region sm may be in direct contact with each other. Another grain without soft magnetism may be interposed between the plurality of soft magnetic grains 6 aligned in the soft magnetic region sm. For example, one or more sub-phase grains 8 may be interposed between the plurality of soft magnetic grains 6 aligned in the soft magnetic region sm. That is, the plurality of soft magnetic grains 6 and the one or more sub-phase grains 8 may be aligned along a direction (AB direction) that is approximately orthogonal or completely orthogonal to the easy magnetization axis direction C in each of the plurality of soft magnetic regions sm. The soft magnetic region sm may be referred to as a soft magnetic layer. A width (length) of the soft magnetic region sm in the direction (AB direction) orthogonal to the easy magnetization axis direction C is not limited. For example, the width (length) of the soft magnetic region sm in the direction (AB direction) orthogonal to the easy magnetization axis direction C may range from 50 μm to 300 μm.

The plurality of main phase grains 4 and the plurality of soft magnetic regions sm are alternately arranged in the easy magnetization axis direction C. In other words, one or more main phase grains 4 are interposed between a pair of soft magnetic regions sm in the easy magnetization axis direction C. In other words, one or more main phase grains 4 and one or more soft magnetic grains 6 contained in the soft magnetic regions sm are alternately arranged in the easy magnetization axis direction C. The main phase grain 4 and the soft magnetic region sm (soft magnetic grain 6 in the soft magnetic regions sm) may be in direct contact with each other in the easy magnetization axis direction C. A grain boundary phase may be interposed between the main phase grain 4 and the soft magnetic region sm (soft magnetic grain 6 in the soft magnetic region sm) in the easy magnetization axis direction C.

Since the one or more main phase grains 4 (hard magnetic phase) having crystalline magnetic anisotropy and the plurality of soft magnetic regions sm (soft magnetic layers) having saturation magnetization larger than that of the main phase grains 4 are alternately arranged in the easy magnetization axis direction C, strong exchange interactions are likely to occur between the fine main phase grains 4 and the fine soft magnetic regions sm. Even when magnetizations of the soft magnetic regions sm are reversed, the strong exchange interactions between the main phase grains 4 and the soft magnetic regions sm prevent a reversal magnetic domain from propagating, making the permanent magnet 2 excellent in magnetic hardness and can have a high coercivity. In addition, the inventor speculates that since the plurality of soft magnetic regions sm (soft magnetic layers) are arranged alternately with the main phase grains 4, a magnetostatical magnetic exchange interactions occur between the soft magnetic regions sm and the main phase grains 4. In contrast to an exchange spring magnet (nano composite magnet) in the related art, which requires a direct magnetic coupling state between the main phase grain and the soft magnetic phase in a short-range (for example, a distance of several nm or shorter) to achieve a high residual magnetic flux density, the inventor speculates that the magnetostatic magnetic exchange interactions can occur between the main phase grains 4 and the soft magnetic regions sm in a long-range (for example, a distance of several tens of μm or longer) in the permanent magnet 2 according to this embodiment. Due to the above-described reason, the permanent magnet 2 can have a high residual magnetic flux density derived from large saturation magnetization of the plurality of soft magnetic regions sm. In the exchange spring magnet (nano composite magnet) in the related art, a plurality of soft magnetic grains are not aligned and are randomly dispersed in a hard magnetic phase. Therefore, in the exchange spring magnet in the related art, the mechanism caused by the arrangement of the main phase grains 4 and the soft magnetic regions sm (soft magnetic layers) is not established, and a high residual magnetic flux density and a high coercivity are less likely to be compatible with each other.

An average value of a width S6 (for example, a maximum width) of the plurality of soft magnetic grains 6 in the easy magnetization axis direction C ranges from 20 nm (0.02 μm) to 5 μm. An average value of a grain diameter of the plurality of soft magnetic grains 6, which is measured on the cross-section 2cs parallel to the easy magnetization axis direction C, may be regarded as the average value of the width S6 (for example, a maximum width) of the plurality of soft magnetic grains 6 in the easy magnetization axis direction C. That is, the average value of the grain diameter of the plurality of soft magnetic grains 6 on the cross-section 2cs parallel to the easy magnetization axis direction C ranges from 20 nm to 5 μm. The average value of the grain diameter of the plurality of soft magnetic grains 6 in the easy magnetization axis direction C may range from 50 nm to 5 μm, or from 20 nm to 2.11 μm. An average value of a width L6 (for example, a maximum width) of the plurality of soft magnetic grains 6 in the AB direction orthogonal to the easy magnetization axis direction C may also range from 20 nm to 5 μm, from 50 nm to 5 μm, or from 20 nm to 2.11 μm. At least a part of the soft magnetic grains 6 may be platelet shaped. That is, the width S6 of each of the plurality of soft magnetic grains 6 in the easy magnetization axis direction C may be smaller than the width L6 of each of the plurality of soft magnetic grains 6 in the AB direction orthogonal to the easy magnetization axis direction C.

Since the average value of the width S6 of the plurality of soft magnetic grains 6 ranges from 20 nm to 5 μm, a high coercivity can be achieved due to exchange interactions between the main phase grains 4 and the soft magnetic regions sm (soft magnetic grains 6) in the easy magnetization axis direction C. In a heat treatment step (for example, a hot deforming step to be described later) of the permanent magnet 2, since grain growth of the soft magnetic grains 6 progresses, it is difficult to adjust the average value of the width S6 of the plurality of soft magnetic grains 6 in the easy magnetization axis direction C to less than 20 nm. When the average value of the width S6 of the plurality of soft magnetic grains 6 exceeds 5 μm, magnetization reversal occurs due to a local demagnetizing field, and thus the coercivity significantly decreases. In the exchange spring magnet (nano composite magnet) in the related art, it is theoretically predicted that a critical value (upper limit value) of the grain diameter of each of the main phase grains 4 and the soft magnetic grains 6 is 10 nm in order to achieve a high coercivity and a high residual magnetic flux density. Contrary to the prediction in the related art, the inventor's research demonstrated that even though the average value of the width S6 of the plurality of soft magnetic grains 6 in the easy magnetization axis direction C is 20 nm or more, a high residual magnetic flux density and a high coercivity are compatible with each other.

In this embodiment, the inventor speculates that since magnetic coupling between a hard magnetic phase and a soft magnetic phase is formed magnetostatically, which eases the severe restriction on the grain diameter of each of the main phase grains 4 and the soft magnetic grains 6. Furthermore, in this embodiment, since the grain diameter and the distribution of the soft magnetic grains 6 are optimized, a high residual magnetic flux density can be achieved while maintaining a high coercivity.

For example, the coercivity (HcJ) of the permanent magnet 2 at 23° C. may range from 1103 kA/m to 1473 kA/m.

For example, the residual magnetic flux density (Br) of the permanent magnet 2 at room temperature may range from 1447 mT to 1533 mT.

For example, a squareness ratio (Hk/HcJ) of the permanent magnet 2 may range from 95.2% to 98.8%. Hk is the intensity of the demagnetizing field corresponding to 90% of the residual magnetic flux density in a second quadrant of a magnetization curve of the permanent magnet 2.

An average value of an interval i of the plurality of soft magnetic regions sm in the easy magnetization axis direction C may range from 4 μm to 15 μm, from 4.03 μm to 12.17 μm, or from 4.23 μm to 12.17 μm. In other words, the average value of the interval i of the plurality of soft magnetic grains 6 contained in the plurality of soft magnetic regions sm in the easy magnetization axis direction C may range from 4 μm to 15 μm, from 4.03 μm to 12.17 μm, or from 4.23 μm to 12.17 μm. In a case where the average value of the interval i of the plurality of soft magnetic regions sm is within the above-described range, a high residual magnetic flux density is likely to be achieved while maintaining a high coercivity. For example, the interval i of the plurality of soft magnetic regions sm in the easy magnetization axis direction C may be a distance between a pair of the soft magnetic grains 6 adjacent to each other on any reference line Lc parallel to the easy magnetization axis direction C in the cross-section 2cs parallel to the easy magnetization axis direction C. For example, the average value of the interval i of the plurality of soft magnetic regions sm in the easy magnetization axis direction C may be an average value of all intervals i measured on any 10 reference lines Lc parallel to the easy magnetization axis direction C.

An area fraction (an area ratio) of the plurality of soft magnetic grains 6 in the cross-section 2cs may range from 4% to 15%, or from 4.11% to 12.10%. An average value of the area fraction of the plurality of soft magnetic grains 6 in the cross-section 2cs may range from 4% to 15%, or from 4.11% to 12.10%. For example, an area of a region II (region II shown in FIG. 2) that is any part of the cross-section 2cs parallel to the easy magnetization axis direction C may be expressed as Acs, and the sum of areas (cross-sectional areas) of all of the soft magnetic grains 6 existing within the region II may be expressed as Asm, and the area fraction Ra may be defined as Asm/Acs. That is, Asm/Acs may range from 0.04 to 0.15. In a case where the area fraction is 4% or more, the permanent magnet 2 is likely to have a high residual magnetic flux density derived from the plurality of soft magnetic grains 6. In a case where the area fraction is 15% or less, magnetization reversal starting from the soft magnetic grain 6 is likely to be suppressed, and the permanent magnet 2 is likely to have a high coercivity. For example, the area fraction of the plurality of main phase grains 4 in the cross-section 2cs may range from 80% to 96%, from 90% to 96%, or from 95% to 96%.

For example, a volume ratio of the plurality of main phase grains 4 (volume ratio of all of the main phase grains 4 in the permanent magnet 2) may range from 80% by volume to 96% by volume, from 90% by volume to 96% by volume, or from 95% by volume to 96% by volume. For example, the volume ratio of the plurality of soft magnetic grains 6 (the volume ratio of all of the soft magnetic grains 6 in the permanent magnet 2) may range from 4% by volume to 15% by volume, or from 4.11% by volume to 12.10% by volume.

As described above, the plurality of main phase grains 4 observed in the cross-section 2cs parallel to the easy magnetization axis direction C may have platelet shapes. For example, a width S4 of each of the plurality of main phase grains 4 (primary grains) in the easy magnetization axis direction C may be smaller than a width L4 of each of the plurality of main phase grains 4 in the AB direction orthogonal to the easy magnetization axis direction C. In other words, a length (S4) of a short axis of each of the plurality of main phase grains 4 may be smaller than a length (L4) of a long axis of each of the plurality of main phase grains 4. For example, an average value of the width S4 of the plurality of main phase grains 4 in the easy magnetization axis direction C may range from 20 nm to 200 nm, or from 67 nm to 95 nm. For example, the average value of the width L4 of the plurality of main phase grains 4 in the AB direction orthogonal to the easy magnetization axis direction C may range from 100 nm to 1000 nm. For example, an average value of an aspect ratio L4/S4 of each of the plurality of main phase grains 4 may range from 2 to 10. For example, in a case where the permanent magnet 2 is manufactured by a hot deforming step to be described later, when the aspect ratio L4/S4 is 2 or more, a c-axis of the main phase grain 4 is likely to be oriented in the easy magnetization axis direction C, and the coercivity is likely to increase. The aspect ratio L4/S4 of 2 or more represents that anisotropic grain growth of the main phase grain 4 (a crystal of R₂T₁₄B) in the hot deforming step is sufficiently progressing. Since there is a limit in the grain growth of the main phase grain 4 in the hot deforming step, the aspect ratio L4/S4 is difficult to exceed 10.

A shape of the main phase grain 4 on the cross-section 2cs is not limited to a rectangle. The shape of the main phase grains 4 on the cross-section 2cs may be distorted. The shapes of the main phase grains 4 on the cross-section 2cs does not have to be uniform. In a case where the shape of the main phase grain 4 on the cross-section 2cs is distorted, the shape of the main phase grain 4 may be approximated by a quadrangle with the smallest area among quadrangles circumscribing the main phase grain 4. The quadrangle may be a rectangle. A length of a short side of the quadrangle may be regarded as the length of the short axis of the main phase grain 4, and a length of a long side of the quadrangle may be regarded as the length of the long axis of the main phase grain 4. An average value of the length of the short axis of the main phase grains 4 may be calculated from measured values of the length of the short axis of all of the main phase grains 4 existing in a back scattered electron image of the cross-section 2cs taken by a scanning electron microscope (SEM). An average value of the length of the long axis of the main phase grains 4 may also be calculated from measured values of the length of the long axis of all of the main phase grains 4 existing in the back scattered electron image. However, dimensions of the main phase grains 4 protruding from the back scattered electron image are excluded from the calculation of the average values. For example, the maximum value of the dimensions of the back scattered electron image used for the measurement of the length of each of the short axis and the long axis of the main phase grain 4 may be 120 μm (length)×80 μm (width), or 80 μm (length)×120 μm (width). A plurality of representative sites in the back scattered electron image taken at low magnification may be selected, and a back scattered electron image at each site may be taken at high magnification. Furthermore, the average value of each of the long axis and the short axis may be calculated from the length of each of the long axis and the short axis of all of the main phase grains 4 which are measured in the back scattered electron image with high magnification. Commercially available image analysis software may be used for specifying a shape (contour line) of the main phase grain 4 and for measuring the dimensions of the main phase grain 4 (the quadrangle circumscribing the main phase grain 4).

Each of the main phase grains 4 may be composed of a surface layer portion, and a central portion covered with the surface layer portion. The surface layer portion may be referred to as a shell, and the central portion may be referred to as a core. The surface layer portion of the main phase grain 4 may contain at least one kind of heavy rare-earth element between Tb and Dy. The surface layer portion of each of all of the main phase grains 4 may contain at least one kind of heavy rare-earth element between Tb and Dy. The surface layer portion of some main phase grains 4 among all of the main phase grains 4 may contain at least one kind of heavy rare-earth element between Tb and Dy. When the surface layer portion contains the heavy rare-earth element, an anisotropic magnetic field is likely to locally increase in the vicinity of the main phase grains, and a nucleus of magnetization reversal is less likely to be generated in the vicinity of the main phase grains. As a result, the coercivity of the permanent magnet 2 at a high temperature (for example, from 100° C. to 200° C.) increases. For the purpose that the residual magnetic flux density (Br) and the coercivity of the permanent magnet 2 are likely to be compatible with each other, the sum of a concentration of the heave rare-earth element in the surface layer portion may be higher than the sum of a concentration of the heavy rare-earth element in the central portion.

As described above, one or more sub-phase grains 8 may be interposed between the plurality of soft magnetic grains 6 aligned in the soft magnetic regions sm. For example, the sub-phase grain 8 may contain at least one among an oxide of the rare-earth element R and metals consisting of the rare-earth element R. The sub-phase grain 8 may consist only of at least one among the oxide of the rare-earth element R and the metals consisting of the rare-earth element R. For example, the oxide of the rare-earth element R contained in the sub-phase grain 8 may be Nd₂O₃ or NdO. For example, the metal contained in the sub-phase grain 8 may be a crystal of Nd having a hexagonal closed-packed structure. The sub-phase grain 8 containing the crystal of Nd may be ferromagnetic and magnetically soft. The sub-phase grain 8 does not have to be magnetically hard, soft or ferromagnetic.

The permanent magnet 2 may further contain a grain boundary phase. For example, the grain boundary phase may exist at a grain boundary (grain boundary multiple junction) surrounded by three or more main phase grains 4. For example, the grain boundary phase may exist at a grain boundary (two-grain boundary) between two main phase grains 4. For example, the grain boundary phase may exist between the main phase grain 4 and the soft magnetic region sm (soft magnetic grain 6). For example, the grain boundary phase may exist between the soft magnetic grain 6 and the sub-phase grain 8.

For example, at least a part of grain boundary phases may be an R-rich phase. The R-rich phase may be a ferromagnetic material and a soft magnetic material. The R-rich phase contains at least the rare-earth element R. For example, the R-rich phase may contain Nd as R. The R-rich phase may further contain one or more kinds of different rare-earth elements in addition to Nd as R. The R-rich phase may contain one or more kinds of heavy rare-earth elements in addition to Nd as R. The R-rich phase may further contain one or more kinds of elements other than R in addition to R. The R-rich phase may contain at least one selected from the group consisting of a metal elementary substance, an alloy, an intermetallic compound, and an oxide. For example, a part or all of R-rich phases may consist only of at least one among an elementary substance of R, an alloy containing R, and a metal compound containing R. A part or all of R-rich phases may contain an R-oxide. For example, the R-oxide may be an Nd-oxide. An oxidized surface of the main phase grain 4 may be an R-oxide. Some R-rich phases may consist only of an R-oxide. A concentration (unit: atomic %) of R in the R-rich phase may be higher than an average value of a concentration of R in the main phase grains 4. A concentration of R in the R-rich phase may be higher than an average value of a concentration of R in the cross-section 2cs. In a case where the permanent magnet 2 contains a plurality of kinds of R, a concentration of R may be the sum of concentrations of the plurality of kinds of R. The permanent magnet 2 may contain a grain boundary phase other than the R-rich phase. For example, the permanent magnet 2 may contain at least one grain boundary phase between R—Fe—Ga—Cu phase and an R—Fe—Co—Cu phase. The R—Fe—Ga—Cu phase is a phase containing R, Fe, Ga, and Cu. The R—Fe—Co—Cu phase is a phase containing R, Fe, Co, and Cu.

For example, the permanent magnet 2 may contain a grain boundary phase containing an element that is introduced into the permanent magnet 2 by a grain boundary diffusion step to be described later. For example, the element that is introduced into the permanent magnet 2 by the grain boundary diffusion step may be at least one kind of heavy rare-earth element between Tb and Dy. The element that is introduced into the permanent magnet 2 by the grain boundary diffusion step may be the heavy rare-earth element and the light rare-earth element, and the light rare-earth element may be at least one between Nd and Pr. The element that is introduced into the permanent magnet 2 by the grain boundary diffusion step may be a heavy rare-earth element, a light rare-earth element, and copper. A eutectic alloy such as Nd—Cu, and Nd—Al may be introduced into the permanent magnet 2 by the grain boundary diffusion step.

For example, a width of the permanent magnet 2 in the easy magnetization axis direction C may range from several mm to several hundreds of mm, or from several tens of mm to several hundreds of mm. For example, a width of the permanent magnet 2 in the AB direction may range from several mm to several hundreds of mm, or from several tens of mm to several hundreds of mm.

Each of the main phase grain 4, the soft magnetic grain 6, the sub-phase grain 8, and the grain boundary phase can be identified on the basis of a contrast of the back scattered electron image of the cross-section 2cs of the permanent magnet 2 which is taken by a scanning electron microscope (SEM). As an atomic weight of an atom increases, a luminance (unit: any unit) of the atom in the back scattered electron image increases. An atomic weight of Fe is smaller than an atomic weight of the rare-earth element R. Accordingly, a luminance of Fe in the back scattered electron image is lower than a luminance of the rare-earth element R in the back scattered electron image. A concentration (unit: atomic %) of Fe in the soft magnetic grain 6 is higher than a concentration of Fe at a portion other than the soft magnetic grain 6 in the cross-section 2cs. A concentration of the rare-earth element R in the soft magnetic grain 6 is lower than a concentration (unit: atomic %) of the rare-earth element R at a portion other than the soft magnetic grain 6 in the cross-section 2cs. Accordingly, the luminance of the soft magnetic grain 6 in the back scattered electron image of the cross-section 2cs is lower as compared with a portion other than the soft magnetic grain 6 in the cross-section 2cs. That is, a dark portion (portion where a grayscale value is large) in the back scattered electron image of the cross-section 2cs corresponds to the soft magnetic grain 6. A composition of each of the main phase grain 4, the soft magnetic grain 6, the sub-phase grain 8, and the grain boundary phase may be analyzed by an energy dispersive X-ray spectrometer (EDS) mounted in a SEM or a STEM.

A composition of the whole of the permanent magnet 2 is described below. However, the composition of the permanent magnet 2 is not limited to the following composition. A content of each element in the permanent magnet 2 may be out of the following range.

For example, a content of the rare-earth element R in the permanent magnet 2 may range from 26% by mass to 32% by mass. In a case where a content of R is 26% by mass or more, a liquid phase (R-rich phase) is likely to be generated in a grain boundary in a process of manufacturing the permanent magnet 2, and the coercivity of the permanent magnet 2 is likely to increase. In addition, in a case where a content of R is 26% by mass or more, excessive formation of a soft magnetic phase (α-Fe phase or the like) is suppressed, a maximum value of a width (grain diameter) of the soft magnetic grain 6 and an interval of the soft magnetic regions in the easy magnetization axis direction are easily controlled within desired ranges. On the other hand, in a case where a content of R is 32% by mass or less, excessive generation of the liquid phase (R-rich phase) is suppressed, and a volume ratio of the main phase is likely to increase. In addition, in a case where a content of R is 32% by mass or less, in a ribbon preparation step (rapid-solidification method) to be described later, a soft magnetic phase that is a precursor of the soft magnetic grain 6 is likely to precipitate at a surface of the alloy ribbon.

With the aim to achieve high residual magnetic flux density and large coercivity simultaneously, the sum of ratios of Nd and Pr in all rare-earth element R may range from 80 atomic % to 100 atomic %, or from 95 atomic % to 100 atomic %.

The sum of contents of Tb and Dy in the permanent magnet 2 may range from 0.00% by mass to 5.00% by mass. When the permanent magnet 2 contains at least one kind of heavy rare-earth element between Tb and Dy, magnetic characteristics (particularly, coercivity at a high temperature) of the permanent magnet 2 are likely to increase. Note that the permanent magnet 2 does not have to contain Tb and Dy.

A content of B in the R-T-B based permanent may range from 0.77% by mass to 1.15% by mass. In a case where a content of B is 0.77% by mass or more, formation of a foreign phase such as TbCu₇ type R₂Fe₁₇ phase having in-plane anisotropy is appropriately suppressed, and the coercivity is likely to increase. In a case where a content of B is 1.15% by mass or less, formation of a foreign phase such as R_{1+ε}Fe₄B₄ (boride) is suppressed, and the coercivity is likely to increase. In a case where a content of B is within the above-described range, the squareness ratio of the permanent magnet 2 is likely to approximate to 1.0.

The permanent magnet 2 may contain gallium (Ga). For example, a content of Ga may range from 0.03% by mass to 1.00% by mass, or 0.20% by mass to 0.80% by mass. In a case where a content of Ga is within the above-described range, generation of a sub-phase (for example, phases including R, T, and Ga) is appropriately suppressed, and the residual magnetic flux density and the coercivity of the permanent magnet 2 are likely to increase. Note that the permanent magnet 2 does not have to contain Ga.

The permanent magnet 2 may contain aluminum Al. For example, a content of Al in the permanent magnet 2 may range from 0.01% by mass to 0.2% by mass, or 0.04% by mass to 0.07% by mass. When a content of Al is within the above-described range, the coercivity and corrosion resistance of the permanent magnet are likely to be improved. Note that the permanent magnet 2 does not have to contain Al.

The permanent magnet 2 may contain copper (Cu). For example, a content of Cu in the permanent magnet 2 may range from 0.01% by mass to 1.50% by mass, or 0.04% by mass to 0.50% by mass. When a content of Cu is within the above-described range, the permanent magnet 2 is easily forged, and the coercivity, the corrosion resistance, and temperature characteristics of the permanent magnet 2 are likely to be improved. Note that the permanent magnet 2 does not have to contain Cu.

The permanent magnet 2 may contain cobalt (Co). For example, a content of Co in the permanent magnet 2 may range from 0.30% by mass to 6.00% by mass, or 0.30% by mass to 4.00% by mass. When the permanent magnet 2 contains Co, a Curie temperature of the permanent magnet 2 is likely to increase. In addition, when the permanent magnet 2 contains Co, the corrosion resistance of the permanent magnet 2 is likely to be improved. Note that the permanent magnet 2 does not have to contain Co.

The balance after excluding the above-described elements from the permanent magnet 2 may be only Fe, or Fe and other elements. In order for the permanent magnet 2 to have sufficient magnetic characteristics, the sum of contents of elements other than Fe in the balance may be 5% by mass or less with respect to the total mass of the permanent magnet 2.

The permanent magnet 2 may contain at least one element selected from the group consisting of silicon (Si), titanium (Ti), Mn (manganese), Zr (zirconium), vanadium (V), chromium (Cr), nickel (Ni), niobium (Nb), molybdenum (Mo), hafnium (Hf), tantalum (Ta), tungsten (W), bismuth (Bi), tin (Sn), calcium (Ca), carbon (C), nitrogen (N), oxygen (O), chlorine (CI), sulfur(S), and fluorine (F) as the other elements (for example, as inevitable impurities). For example, the sum of contents of the other elements in the permanent magnet 2 may range from 0.001% by mass to 0.50% by mass.

For example, the composition of the whole of the permanent magnet 2 may be analyzed by X-ray fluorescence (XRF) analysis, high-frequency inductively-coupled plasma (ICP) emission spectrometry, an inert gas melting-non-dispersive infrared absorption (NDIR) method, a oxygen stream combustion-infrared absorption method, and an inert gas melting-infrared thermal conductivity method, and the like.

The permanent magnet 2 may be applied to a motor, a generator, an actuator, or the like. For example, the permanent magnet 2 is used in various fields such as a hybrid vehicle, an electric vehicle, a hard disk drive, a magnetic resonance imaging apparatus (MRI), a smartphone, a digital camera, a slim-type TV, a scanner, an air conditioner, a heat pump, a refrigerator, a vacuum cleaner, a washing and drying machine, an elevator, and a wind power generator.

### (Method of Manufacturing Permanent Magnet)

A method of manufacturing a permanent magnet according to this embodiment may include a ribbon preparation step, a hot pressing step, and a hot deforming step. The method of manufacturing the permanent magnet may further include another step such as a grain boundary diffusion step subsequent to the hot deforming step. However, the grain boundary diffusion step is not essential.

In order to suppress oxidation of the permanent magnet and its work in process during a manufacturing process, the method of manufacturing the permanent magnet may be carried out under a non-oxidative atmosphere. For example, the non-oxidative atmosphere may be an inert gas such as an argon (Ar) gas. The non-oxidative atmosphere may further contain a reductive gas such as a hydrogen gas (H₂) in addition to the inert gas.

The ribbon preparation step is a step of preparing alloy ribbons from a raw material metal by a rapid-solidification method. In the rapid-solidification method, a molten metal in a crucible is ejected to a surface of cooled roll from a nozzle located at a tip end of the crucible. The molten metal comes into contact with the surface of the cooled roll, is flicked away instantaneously by the cooled roll rotating at a high speed, and forms a large number of elongated ribbons. Due to the contact with the surface of the cooled roll, the molten metal is rapidly cooled and solidified. As a result, the large number of elongated alloy ribbons are formed. In a direction in which the alloy ribbons are flicked away by the cooled roll, a container is installed, and the alloy ribbons are collected in the container. The alloy ribbons may have an amorphous microstructure. The alloy ribbons are crystallized due to heating in a hot pressing step to be described later. A soft magnetic phase (for example, an α-Fe phase) that is a precursor of the soft magnetic grain in the permanent magnet precipitates at surfaces of the alloy ribbons. A surface, where the soft magnetic phase (for example, the α-Fe phase) is likely to precipitate, among surfaces of the alloy ribbon is a rear surface of a surface coming into contact with the cooled roll. Since a process in which the alloy ribbons are formed by the rapid-solidification method is a thermodynamically non-equilibrium process, even though the molten metal has a composition in which the soft magnetic phase is not formed in an equilibrium phase diagram, the soft magnetic phase (for example, the α-Fe phase, and the R-T phase) can be formed at the surfaces of the alloy ribbons.

The R-T phase among soft magnetic phases is a metastable phase, and in the hot deforming step, the R-T phase reacts with a liquid phase including the rare-earth element R as a main component, and the R-T phase is likely to be decomposed into the main phase and the α-Fe phase. As a content of the rare-earth element R in the alloy ribbon is larger, the liquid phase is likely to be generated in the hot deforming step, the R-T phase is likely to be decomposed due to reaction with the liquid phase, and a ratio of the α-Fe phase in the soft magnetic grain is likely to increase. Since a saturation magnetization of the α-Fe phase is higher than a saturation magnetization of the R-T phase, as a content of the α-Fe phase in the soft magnetic grain increases, the residual magnetic flux density of the permanent magnet is likely to increase.

The molten metal is a metal (raw material metals) containing respective elements constituting the permanent magnet. For example, the raw material metals may be an elementary substance (metal elementary substance) of a rare-earth element, an alloy including the rare-earth element, pure iron, ferroboron, or alloys including these materials. The raw material metals are weighed to match a desired composition of the permanent magnet.

The molten metal may be obtained by heating the raw material metals in the crucible with high-frequency induction heating. For example, a temperature (ejecting temperature) of the molten metal ejected from the nozzle may range from 1300° C. to 1400° C. For example, a temperature-rising rate until the temperature of the raw material metals reach the ejecting temperature may range from approximately 20° C./second to approximately 100° C./second.

For example, the nozzle may be made of quartz. For example, a hole diameter of the nozzle may range from 0.6 mm to 1.0 mm. In a case where the hole diameter of the nozzle is less than 0.6 mm, the average value of the interval of the plurality of soft magnetic regions in the easy magnetization axis direction is likely to exceed 15 μm. In a case where the hole diameter of the nozzle exceeds 1.0 mm, the average value of the interval of the plurality of soft magnetic regions in the easy magnetization axis direction is likely to be less than 4 μm, and an average value of the width (grain diameter) of the plurality of soft magnetic grains in the easy magnetization axis direction is likely to exceed 5 μm.

In order to suppress oxidation of the molten metal, an atmosphere inside the crucible of the molten metal may be substituted with an inert gas such as an argon (Ar) gas. For example, an atmospheric pressure inside the crucible of the molten metal may range from 100 kPa to 240 kPa. The cooled roll is installed inside a chamber. In order to suppress oxidation of the molten metal and the alloy ribbon (generation of the R-oxide), the atmosphere inside the chamber may be substituted with an inert gas such as an argon (Ar) gas. For the same reason, the atmosphere inside the chamber may contain a reductive gas such as a hydrogen gas (H₂) in addition to the inert gas. For example, the atmospheric pressure inside the chamber may range from 60 kPa to 200 kPa.

The atmospheric pressure inside the crucible of the molten metal is higher than the atmospheric pressure inside the chamber. The difference between the atmospheric pressure inside the crucible of the molten metal and the atmospheric pressure inside the chamber is a pressure (ejecting differential pressure) of the molten metal ejected from the nozzle. For example, the ejecting differential pressure may be adjusted to from 10 kPa to 40 kPa, or from 20 kPa to 40 kPa.

As the ejecting differential pressure increases, the average value of the width (grain diameter) of the plurality of soft magnetic grains in the easy magnetization axis direction increases. In a case where the ejecting differential pressure is 10 kPa or more, the average value of the width (grain diameter) of the plurality of soft magnetic grains in the easy magnetization axis direction is likely to be controlled to a value of 2 nm or more. In a case where the ejecting differential pressure exceeds 40 kPa, the average value of the width (grain diameter) of the plurality of soft magnetic grains in the easy magnetization axis direction is likely to exceed 5 μm.

In a case where the ejecting differential pressure is less than 20 kPa, the average value of the interval of the plurality of soft magnetic regions in the easy magnetization axis direction is likely to exceed 15 μm. In a case where the ejecting differential pressure exceeds 40 kPa, the average value of the interval of the plurality of soft magnetic regions in the easy magnetization axis direction is likely to be less than 4 μm.

For example, the surface of the cooled roll may be composed of a metal (such as Cu) having high thermal conductivity. The temperature of the surface of the cooled roll may be controlled by a coolant flowing through the inside of the cooled roll. For example, the temperature of the surface of the cooled roll may be controlled so that a cooling rate of the molten metal on the surface of the cooled roll becomes from approximately 105° C./second to approximately 106° C./second. In a case where the cooling rate of the molten metal is adjusted to from approximately 105° C./second to approximately 106° C./second, an alloy ribbon composed of a microstructure in which a nano-scale main phase (R₂T₁₄B) and a soft magnetic phase (α-Fe phase or the like) are mixed in is likely to be formed. As the cooling rate is higher, a crystal grain diameter of each of the main phase (R₂T₁₄B) and the soft magnetic phase (α-Fe phase or the like) contained in the alloy ribbon is likely to be fine, and the coercivity of the permanent magnet is likely to increase. As the amount of the molten metal ejected to the surface of the cooled roll per unit time is smaller, the amount of the molten metal adhering to the surface of the cooled roll becomes thinner, and the cooling rate becomes higher, and the ally ribbon also becomes thinner. As a circumferential speed of the cooled roll is higher, the molten metal adhering to the surface of the cooled roll becomes thinner, the cooling rate becomes higher, and the alloy ribbon also becomes thinner. The thickness of the main phase grain in the easy magnetization axis direction (the length of a short axis of the main phase grain) depends on the thickness of the alloy ribbon (and pulverization and classification of the alloy ribbon). As the alloy ribbon is thinner, the thickness (grain diameter) of the main phase grain decreases, and the coercivity of the permanent magnet tends to increase. For example, a thickness of the alloy ribbon may range from 20 μm to 60 μm, or from 30 μm to 50 μm. For example, the width of the alloy ribbon may range from 1.0 mm to 5.0 mm.

For example, the circumferential speed range of the cooled roll may be from 30 m/second to 60 m/second.

As the circumferential speed of the cooled roll decreases, the area fraction of the plurality of soft magnetic grains in the cross-section (cross-section parallel to the easy magnetization axis direction) of the permanent magnet increases. In a case where the circumferential speed of the cooled roll is less than 40 m/second, the area fraction of the plurality of soft magnetic grains in the cross-section (cross-section parallel to the easy magnetization axis direction) of the permanent magnet is likely to be controlled to a value of 4% or more. In a case where the circumferential speed of the cooled roll is less than 30 m/second, the area fraction of a plurality of soft magnetic grains in the cross-section (cross-section parallel to the easy magnetization axis direction) of the permanent magnet is likely to exceed 15%.

As the circumferential speed of the cooled roll decreases, the average value of the interval of the plurality of soft magnetic regions in the easy magnetization axis direction decreases. In a case where the circumferential speed of the cooled roll is less than 20 m/second, the average value of the interval of the plurality of soft magnetic regions in the easy magnetization axis direction is likely to be less than 4 μm.

As the circumferential speed of the cooled roll decreases, the average value of the width (grain diameter) of the plurality of soft magnetic grains in the easy magnetization axis direction increases. In a case where the circumferential speed of the cooled roll is 60 m/second or less, the average value of the width (grain diameter) of the plurality of soft magnetic grains in the easy magnetization axis direction is likely to be controlled to a value of 2 nm or more. In a case where the circumferential speed of the cooled roll is less than 30 m/second, the average value of the width (grain diameter) of the plurality of soft magnetic grains in the easy magnetization axis direction is likely to exceed 5 μm.

After the ribbon preparation step, a pulverization/classification step may be carried out. The pulverization/classification step is a step of pulverizing the alloy ribbons by using a pulverization device to prepare a coarse powder, and classifying the coarse powder to collect an alloy powder having a predetermined particle size and a predetermined aspect ratio. The alloy powder is precursors of the main phase grains contained in the permanent magnet. A shape of alloy particles constituting the alloy powder may be a plate shape or a flake shape. For example, a method of pulverizing the alloy ribbons may be at least one method between a cutter mill and a propeller mill. A unit of classifying the coarse powder is a sieve. For example, a particle size and a particle size distribution of the alloy powder obtained through the classification may be measured by a laser diffraction scattering method. For example, the particle diameter of the alloy powder obtained through the classification may range from 60 μm to 2800 μm, or 150 μm to 2800 μm.

The hot pressing step is a step of pressing the alloy ribbons (alloy powder) while heating the alloy ribbons to form a compact. For example, the alloy powder may be compressed with a mold while heating the alloy powder inside the mold. Voids between alloy powder decreases by pressing the alloy powder to obtain a dense compact. The alloy powder is crystallized by heating of the alloy powder accompanying the pressing. Furthermore, a liquid phase (an R-rich phase such as an Nd-rich phase) is formed from a surface of the alloy powder due to heating of the alloy powder accompanying the pressing, the liquid phase fills voids (grain boundaries) between the alloy powder, and the liquid phase lubricates the alloy powder, and thus a dense compact is obtained. A cold pressing step may be carried out before the hot pressing step. In the cold pressing step, the compact may be formed by pressing the alloy powder at normal temperature (room temperature). The compact may be dense by pressing the compact obtained by the cold pressing step while heating the compact in the hot pressing step. For example, a temperature (hot pressing temperature) of the alloy powder in the hot pressing step may range from 550° C. to 800° C. In a case where the hot pressing temperature is too low, a sufficient liquid phase is not formed from the surface of the alloy powder, and the compact is less likely to be dense. In a case where the hot pressing temperature is excessively high, grain growth of the crystal (R₂T₁₄B) constituting the alloy powder is likely to progress excessively, and the coercivity of the permanent magnet is likely to decrease. For example, a pressure (hot pressing pressure) applied to the alloy powder in the hot pressing step may range from 50 MPa to 300 MPa. For example, a time (hot pressing time) for which the hot pressing temperature and the hot pressing pressure are kept in the above-described ranges, may range from several tens of seconds to several hundreds of seconds.

The hot deforming step is carried out after the hot pressing step. The hot deforming step is a step of heating and pressing the compact obtained by the hot pressing step to obtain a magnet base material containing a plurality of main phase grains (crystal grains of R₂T₁₄B) in which a c-axis (easy magnetization axis) is oriented in a predetermined direction. For example, as the hot deforming step, die upset forging may be carried out. For example, as the hot deforming step, hot extrusion may be carried out.

A grain boundary phase in the compact is liquefied by heating during the hot deforming step, and the liquid phase (R-rich phase) is generated. A stress acts on the compact in a predetermined direction by pressing during the hot deforming step, and respective alloy particles (alloy ribbons) constituting the compact are distorted. In accordance with generation of the liquid phase and deformation of the alloy particles, anisotropic growth of crystal grains in a direction orthogonal to the c-axis of the crystal grains progresses. Furthermore, the liquid phase lubricates the crystal grains, and a force acts on the crystal grains in correspondence with the stress. As a result, the crystal grains rotate due to grain boundary sliding, and the c-axes of the crystal grains (main phase grains) are oriented in parallel to a stress direction. In other words, a plurality of platelet-shaped main phase grains extending in a direction orthogonal to the c-axis are stacked along the stress direction. The easy magnetization axis direction of the magnet base material is approximately or completely parallel to the stress direction. In accordance with the orientation of the crystal grains (main phase grains), the surfaces, where the soft magnetic phases (α-Fe phase or the like) have precipitated, of the alloy ribbons as sources of the main phase grains become approximately or completely orthogonal to the easy magnetization axis direction (stress direction). Furthermore, the soft magnetic phases which have precipitated at the surfaces of the alloy ribbons become a plurality of soft magnetic grains aligned in a direction that is approximately or completely orthogonal to the easy magnetization axis direction. As a result, a plurality of soft magnetic regions (soft magnetic layers) arranged alternately with one or more main phase grains in the easy magnetization axis direction are formed.

For example, a temperature (hot deforming temperature) of the compact in the hot deforming step may be equal to or higher than 700° C. and lower than 900° C., or from 700° C. to 850° C.

In a case where the hot deforming temperature is too low, the liquid phase (an R-rich phase such as an Nd-rich phase) is less likely to be generated at a grain boundary inside the compact, the crystal grains are less likely to grow, and rotation of the crystal grains caused by grain boundary sliding is less likely to occur. As a result, the average value of the length of the short axis of the main phase grains is likely to be less than 20 nm, and the c-axes of the main phase grains (crystal grains) are less likely to be oriented in parallel to the stress direction.

In a case where the hot deforming temperature is excessively high (for example, the hot deforming temperature is 900° C. or higher), the liquid phase (R-rich phase) excessively oozes out from each alloy particle, the liquid phase precipitates at the surface of the alloy particle and an interface of the alloy particles, and the majority of the liquid phase is consumed for grain growth of the crystal grains. Since the majority of the liquid phase is consumed for grain growth of the crystal grains, grain growth of the main phase grains (crystal grains) progresses abnormally, coarse main phase grains are likely to be formed, and the average value of the length of the short axis of the main phase grains is likely to exceed 200 nm. The coarse main phase grains are less likely to be oriented in the easy magnetization axis direction.

For example, the pressure (hot deforming pressure) applied to the compact in the hot deforming step may range from 50 MPa to 200 MPa. For example, a time (hot deforming time) for which the hot deforming temperature and the hot deforming pressure are kept in the above-described ranges may be several tens of seconds.

The magnet base material obtained through the above-described steps may be a finished permanent magnet. A magnet base material that has undergone the following grain boundary diffusion step may be a finished permanent magnet.

The following grain boundary diffusion step may be carried out after a cooling step following the hot deforming step.

For example, in the grain boundary diffusion step, a diffusing material containing a heavy rare-earth element may be attached to the surface of the magnet base material, and the diffusing material and the magnet base material may be heated. Due to heating of the magnet base material to which the diffusing material is attached, a heavy rare-earth element in the diffusing material diffuses from the surface of the magnet base material to the inside of the magnet base material. At the inside of the magnet base material, the heavy rare-earth element diffuses to the vicinity of the surface of the main phase grain through the grain boundary. In the vicinity of the surface of the main phase grain, a part of a light rare-earth element (Nd or the like) is substituted with the heavy rare-earth element. Since the heavy rare-earth element locally exists in the vicinity of the surface of the main phase grain and in the grain boundary, an anisotropic magnetic field is locally enlarged in the vicinity of the surface of the main phase grain facing the grain boundary, and a nucleus of magnetization reversal is less likely to be generated from the surface of the main phase grain. As a result, a permanent magnet having a high coercivity is obtained.

For example, a temperature (diffusion temperature) of the diffusing material containing the heavy rare-earth element and the magnet base material may range from 550° C. to 900° C. For example, a time (diffusion time) for which the diffusion temperature is kept in the above-described range may range from 1 minute to 1440 minutes.

The diffusing material may contain at least one kind of heavy rare-earth element between Tb and Dy. The diffusing material may further contain at least one kind of light rare-earth element between Nd and Pr in addition to the heavy rare-earth element. The diffusing material may further contain Cu in addition to the heavy rare-earth element and the light rare-earth element. For example, the diffusing material may be a metal consisting of one kind of the elements, a hydride of one kind of the elements, an alloy containing a plurality of kinds of the elements, or a hydride of the alloy. The diffusing material may be a powder. In the grain boundary diffusion step, a slurry containing the diffusing material and an organic solvent may be applied to the surface of the magnet base material. In the grain boundary diffusion step, the surface of the magnet base material may be covered with a sheet containing the diffusing material and a binder. In the grain boundary diffusion step, the surface of the magnet base material may be covered with an alloy foil (ribbon) composed of the diffusing material.

A eutectic alloy (Nd—Cu, Nd—Al, and the like) containing the rare-earth element R may be introduced into the magnet base material by the grain boundary diffusion step. For example, the diffusing material containing the eutectic alloy may be attached to the surface of the magnet base material and the diffusing material and the magnet base material may be heated. For example, the diffusing material containing the eutectic alloy may be a fine ribbon consisting of the eutectic alloy. A melting point of the eutectic alloy is lower than a melting point of the magnet base material. Accordingly, when the diffusing material containing the eutectic alloy and the magnet base material are heated at a temperature that is equal to or higher than the melting point of the eutectic alloy and lower than the melting point of the magnet base material, the melted eutectic alloy intrudes and diffuses from the surface of the magnet base material into grain boundaries inside the magnet base material. As a result, a permanent magnet having a high coercivity is likely to be obtained.

The surface of the magnet base material may be polished before the grain boundary diffusion step in order to promote diffusion of the diffusing material. The surface of the magnet base material may be polished after the grain boundary diffusion step in order to remove the diffusing material remaining on the surface of the magnet base material after the grain boundary diffusion step.

Dimensions and a shape of the magnet base material may be adjusted by cutting, polishing, and the like of the magnet base material. A passive layer may be formed on the surface of the magnet base material by oxidation or a chemical treatment of the surface of the magnet base material. The surface of the magnet base material may be covered with a protective film such as a resin film. The corrosion resistance of the permanent magnet is improved due to the passive layer or the protective film.

The present disclosure is not limited to the above-described embodiment. Various modifications of the present disclosure can be made within a range not departing from the gist of the present disclosure, and the modifications are also included in the present disclosure.

### EXAMPLES

The present disclosure will be described in detail with reference to the following examples and comparative examples. The present disclosure is not limited by the following examples.

### Example 1

The following each step of the Example 1 was carried out in a non-oxidative atmosphere (Ar gas).

In a ribbon preparation step, alloy ribbons were prepared from a raw material alloy by the above-described rapid-solidification method. The raw material metal (molten metal) used in the ribbon preparation step consisted of Nd, Fe, Co, Ga, Al, and B.

A content of Nd in the raw material metal was 29.00% by mass.

A content of Fe in the raw material metal was 64.52% by mass.

A content of Co in the raw material metal was 5.02% by mass.

A content of Ga in the raw material metal was 0.53% by mass.

A content of Al in the raw material metal was 0.03% by mass.

A content of B in the raw material metal was 0.90% by mass.

A temperature (ejecting temperature) of the molten metal to be ejected from a nozzle made of quartz was 1300° C. A cooling rate of the molten metal on a surface of a cooled roll made of copper was approximately 105° C./second. A gas (atmosphere) inside a chamber in which the cooled roll was installed was Ar. An atmospheric pressure inside the chamber was 50 kPa.

A gas supplied into a crucible of the molten metal was Ar. An ejecting differential pressure (unit: kPa), that is a difference between the atmospheric pressure inside the crucible of the molten metal and the atmospheric pressure inside the chamber, was a value shown in the following Table 1. A hole diameter (unit: mm) of the nozzle was a value shown in the following Table 1. A circumferential speed (unit: m/second) of the cooled roll was a value shown in the following Table 1.

In the hot pressing step, an alloy powder in a mold was compressed while heating the alloy powder to prepare a compact. The compact was a circular column. A diameter of the end surface of the circular column (that is, the thickness of the circular column) was 10 mm. A height of the circular column was 10 mm. A hot pressing temperature was 700° C. A hot pressing pressure was 300 MPa. A hot pressing time was 180 seconds.

In the hot deforming step, a permanent magnet was prepared from a compact by die upset forging. In the die upset forging, a pressure orthogonal to the end surface of the compact (circular column) was applied to the compact while heating the compact at 800° C. That is, a circular plate-shaped permanent magnet was prepared by pressing the compact in a direction orthogonal to the end surface of the compact. A thickness direction of the permanent magnet was the easy magnetization axis direction C of the permanent magnet. That is, a direction orthogonal to a circular surface of the permanent magnet was the easy magnetization axis direction C. A height of the permanent magnet (thickness of the circular plate) is expressed as hf (unit: mm). A height of the compact (circular column) before pressing is expressed as hi (unit: mm). As described above, hi is 10 mm. A time required until hi decreases to hf is expressed as T (unit: second). T can be rephrased as a time necessary to press the compact. A draft is defined as (hi−hf)/hi×100. A unit of the draft is %. The draft was 78%. That is, hf was 2.2 mm. A press speed is defined as (hi-hf)/T. A unit of the press speed is mm/second. The press speed was 0.1 mm/second. That is, T was 78 seconds.

### Examples 2 to 7 and Comparative Examples 1 to 4

An ejecting differential pressure of each of Examples 2 to 7 and Comparative Examples 1 to 4 was a value shown in the following Table 1. A hole diameter of the nozzle of each of Examples 2 to 7 and Comparative Examples 1 to 4 was a value shown in the following Table 1. A circumferential speed of the cooled roll of each of Examples 2 to 7 and Comparative Examples 1 to 4 was a value shown in the following Table 1.

A permanent magnet of each of Examples 2 to 7 and Comparative Examples 1 to 4 was prepared by the same method as in Example 1 except for the above-described matters.

### Comparative Example 5

A raw material metal (molten metal) used in the ribbon preparation step of Comparative Example 5 consisted of Nd, Tb, Fe, Co, Ga, Al, and B. A composition of the raw material metal of Comparative Example 5 approximately or completely matches a stoichiometric composition of R₂T₁₄B.

A content of Nd in the raw material metal of Comparative Example 5 was 25.62% by mass.

A content of Tb in the raw material metal of Comparative Example 5 was 0.06% by mass.

A content of Fe in the raw material metal of Comparative Example 5 was 70.46% by mass.

A content of Co in the raw material metal of Comparative Example 5 was 2.53% by mass.

A content of Ga in the raw material metal of Comparative Example 5 was 0.20% by mass.

A content of Al in the raw material metal of Comparative Example 5 was 0.18% by mass.

A content of B in the raw material metal of Comparative Example 5 was 0.95% by mass.

An ejecting differential pressure of Comparative Example 5 was a value shown in the following Table 1. A hole diameter of the nozzle of Comparative Example 5 was a value shown in the following Table 1. A circumferential speed of the cooled roll of Comparative Example 5 was a value shown in the following Table 1.

A permanent magnet of Comparative Example 5 was prepared by the same method as in Example 1 except for the above-described matters.

### Examples 8 to 11

A raw material metal (molten metal) used in the ribbon preparation step of each of Examples 8 to 11 consisted of Nd, Fe, Co, Ga, Al, and B.

A content of Nd in the raw material metal of Example 8 was 29.82% by mass.

A content of Fe in the raw material metal of Example 8 was 65.15% by mass.

A content of Co in the raw material metal of Example 8 was 3.59% by mass.

A content of Ga in the raw material metal of Example 8 was 0.53% by mass.

A content of Al in the raw material metal of Example 8 was 0.02% by mass.

A content of B in the raw material metal of Example 8 was 0.89% by mass.

A content of Nd in the raw material metal of Example 9 was 29.66% by mass.

A content of Fe in the raw material metal of Example 9 was 65.24% by mass.

A content of Co in the raw material metal of Example 9 was 3.57% by mass.

A content of Ga in the raw material metal of Example 9 was 0.53% by mass.

A content of Al in the raw material metal of Example 9 was 0.02% by mass.

A content of B in the raw material metal of Example 9 was 0.98% by mass.

A content of Nd in the raw material metal of Example 10 was 29.54% by mass.

A content of Fe in the raw material metal of Example 10 was 65.31% by mass.

A content of Co in the raw material metal of Example 10 was 3.56% by mass.

A content of Ga in the raw material metal of Example 10 was 0.53% by mass.

A content of Al in the raw material metal of Example 10 was 0.02% by mass.

A content of B in the raw material metal of Example 10 was 1.04% by mass.

A content of Nd in a raw material metal of Example 11 was 29.42% by mass.

A content of Fe in a raw material metal of Example 11 was 65.39% by mass.

A content of Co in a raw material metal of Example 11 was 3.55% by mass.

A content of Ga in a raw material metal of Example 11 was 0.52% by mass.

A content of Al in a raw material metal of Example 11 was 0.02% by mass.

A content of B in a raw material metal of Example 11 was 1.10% by mass.

A permanent magnet of each of Examples 8 to 11 was prepared by the same method as in Example 1 except for the above-described matters.

### <Analysis of Permanent Magnet>

### (Composition and Microstructure of Permanent Magnet)

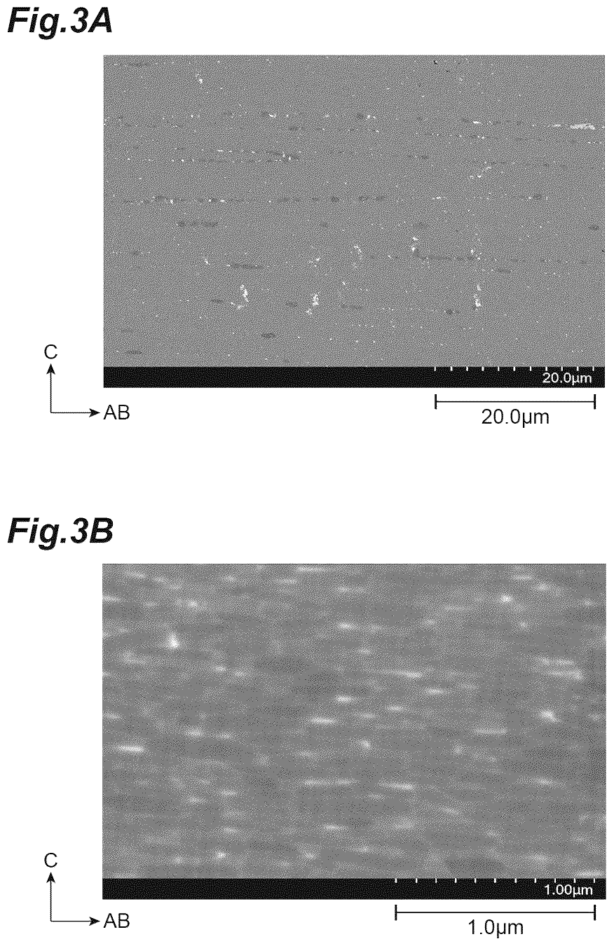

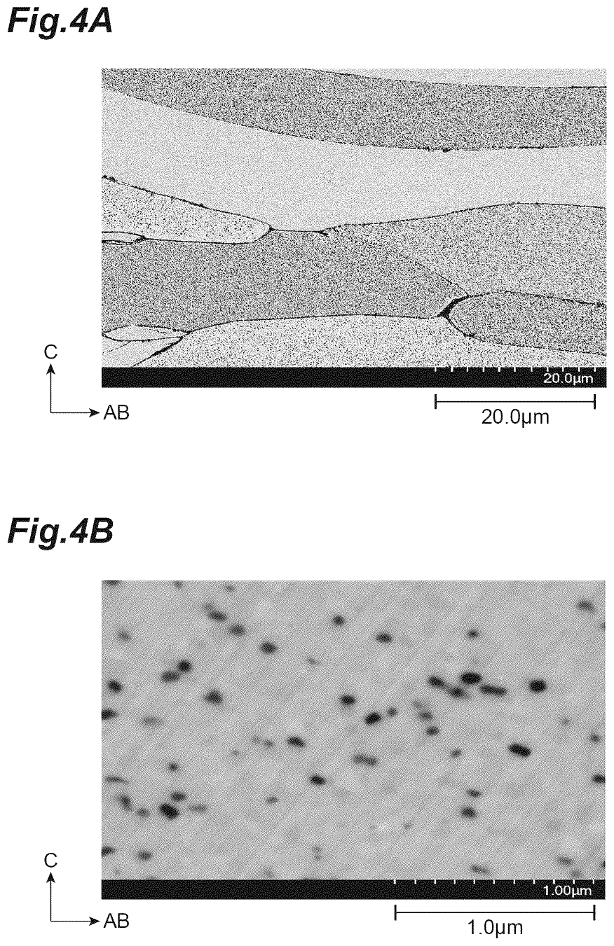

A back scattered electron image of a cross-section of the permanent magnet of each of Examples 1 to 11 and Comparative Examples 1 to 5 was taken by a scanning electron microscope (SEM). The cross-section of each of the permanent magnets was parallel to the easy magnetization axis direction C of the permanent magnet. A composition of the cross-section of the permanent magnet was analyzed by an energy dispersive X-ray spectrometer (EDS) mounted in the SEM. A back scattered electron image of a part of the cross-section in Example 1 is shown in FIGS. 3A and 3B. A back scattered electron image of a part of the cross-section in Comparative Example 5 is shown in FIGS. 4A and 4B.

In any of Examples 1 to 11 and Comparative Examples 1 to 5, the permanent magnet had the following characteristics.

A composition of the whole of the permanent magnet matched the composition of the raw material metal.

The permanent magnet contained a large number of main phase grains (crystal grains of R₂T₁₄B).

Each of the main phase grains contained at least Nd as R, and contained at least Fe as T.

The main phase grains observed in the cross-section were in platelet shape.

A short axis of each of the main phase grains was approximately or completely parallel to the easy magnetization axis direction C.

A long axis of each of the main phase grains was approximately or completely orthogonal to the easy magnetization axis direction C.

A large number of platelet-shaped main phase grains were stacked along the easy magnetization axis direction C.

The permanent magnet contained a plurality of soft magnetic grains.

Each of the soft magnetic grains was identified from other parts as the darkest part in the back scattered electron image of the cross-section (refer to FIG. 3A).

In each of the soft magnetic grains, the sum of contents of Fe and Co was 70% by mass or more. A soft magnetic grain containing an α-Fe phase, a soft magnetic grain containing an Fe₃B phase, and a soft magnetic grain containing an Fe Co phase were detected.

The permanent magnets of all examples had the following characteristics. The permanent magnets of all comparative examples except for Comparative Example 5 also had the following characteristics.

The cross-section of the permanent magnet contained a plurality of soft magnetic regions.

Each of the plurality of soft magnetic regions contained a plurality of soft magnetic grains aligned along the AB direction orthogonal to the easy magnetization axis direction C.

The plurality of main phase grains and the plurality of soft magnetic regions were alternately arranged in the easy magnetization axis direction C.

As shown in FIG. 4B, a plurality of soft magnetic grains were randomly distributed in the cross-section of the permanent magnet of Comparative Example 5. That is, the cross-section of the permanent magnet of Comparative Example 5 did not contain a soft magnetic region containing a plurality of soft magnetic grains aligned along the AB direction orthogonal to the easy magnetization axis direction C.

### (Measurement Relating to Soft Magnetic Grain)

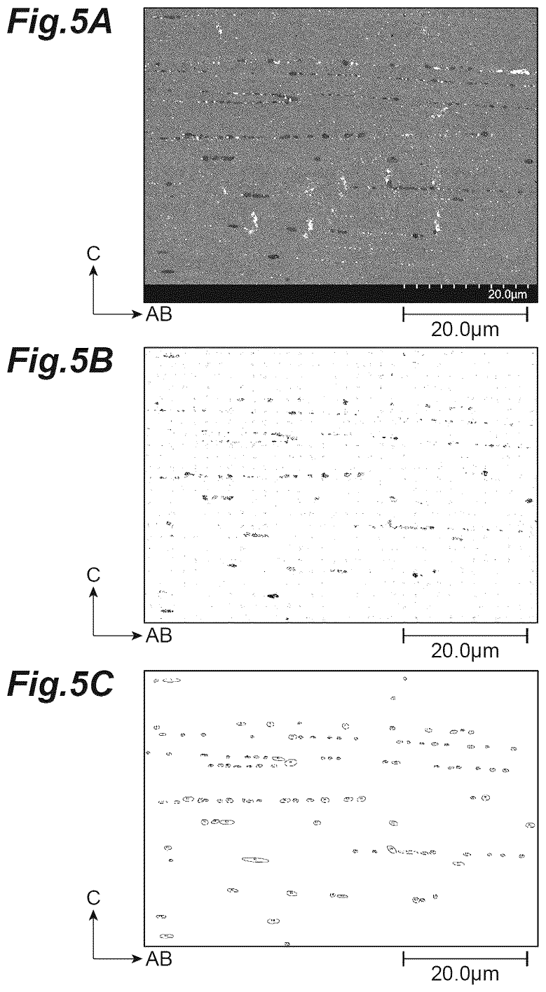

A back scattered electron image of the cross-section of the permanent magnet of Example 1 shown in FIG. 5A is a back scattered electron image that is identical with FIG. 3A. That is, the back scattered electron image in FIG. 5A is parallel to the easy magnetization axis direction C. Dimensions of the back scattered electron image in FIG. 5A were 63.5 μm (length)×47.6 μm (width).

The back scattered electron image in FIG. 5A was converted into a monochrome image in FIG. 5B by threshold processing (binarization processing) based on a red-green-blue color model (RGB color model). Each of dark parts in the monochrome image in FIG. 5B corresponds to the soft magnetic grain. An area of each of the soft magnetic grains in the monochrome image in FIG. 5B was measured. An area fraction of a plurality of soft magnetic grains in the cross-section (the monochrome image in FIG. 5B) of the permanent magnet was calculated on the basis of the measured area of each of the soft magnetic grains.

Area fractions of a plurality of soft magnetic grains in a total of ten regions within the cross-section of the permanent magnet of Example 1 were calculated by the same method as described above. An average value Ra_avg of the area fraction was calculated from the area fractions of the ten regions. The average value Ra_avg of the area fraction of the plurality of soft magnetic grains in Example 1 is shown in the following Table 1.

A contour of each of the soft magnetic grains in the monochrome image in FIG. 5B was extracted by image processing of the monochrome image in FIG. 5B. Each of a plurality of closed curves (ellipses) included in an image shown in FIG. 5C corresponds to the contour of each of the soft magnetic grains in the monochrome image in FIG. 5B. That is, the image in FIG. 5C was obtained by approximating the contour of each of the soft magnetic grains in the monochrome image in FIG. 5B with an ellipse (containing a perfect circle). The approximation of the contour of each of the soft magnetic grains with the ellipse was performed by fitting based on a least squares method. Parts having dimensions equal to or less than (10 nm (length)×10 nm (width)) among dark parts in the monochrome image were removed from the image as noises. Soft magnetic grains that are broken at edges of the image was removed from the image in the image processing of the monochrome image in FIG. 5B.

A length of a long axis of the ellipse that approximates the contour of each of the soft magnetic grains in the image in FIG. 5C was measured. That is, a Feret's diameter of the ellipse that approximates the contour of each of the soft magnetic grains in the image in FIG. 5C was measured. Furthermore, an average value of the length of the long axis of the ellipse that approximates the contour of each of the soft magnetic grains in the image in FIG. 5C was calculated. A width of each of the plurality of soft magnetic grains in the easy magnetization axis direction is equal to or less than the length of the long axis of the ellipse that approximates the contour of each of the soft magnetic grains. Accordingly, the length of the long axis of the ellipse that approximates the contour of each of the soft magnetic grains is regarded as a maximum width of the grain diameter of each of the soft magnetic grains, and is also regarded as a width (maximum width) of each of the soft magnetic grains in the easy magnetization axis direction. An average value of the width of each of the soft magnetic grains in the image in FIG. 5C was calculated.

Back scattered electron images of a total of ten sites in the cross-section of the permanent magnet were taken at the same magnification as in the back scattered electron image in FIG. 5A. One site among the total of ten sites is a part shown in FIG. 5A. Furthermore, an average value of the width (Feret's diameter) of each of the soft magnetic grains in each back scattered electron image was calculated by the same image processing as described above. That is, ten average values were calculated as the average value of the width of the soft magnetic grain. An average value Ws_avg of the width (maximum width) of the plurality of soft magnetic grains in the easy magnetization axis direction was calculated by dividing the sum of the ten average values by ten. The average value Ws_avg of the width of the plurality of soft magnetic grains in Example 1 is shown in the following Table 1.

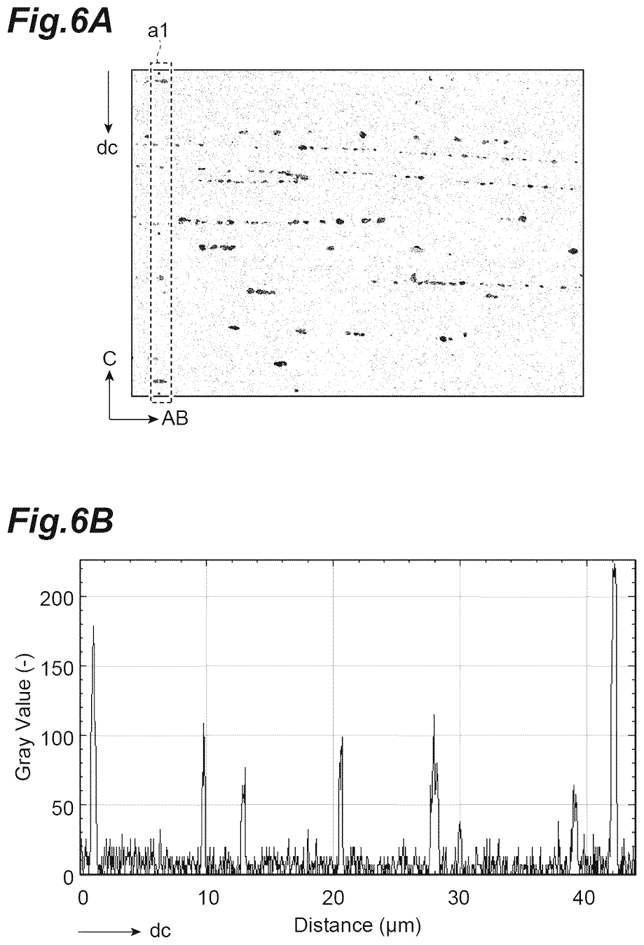

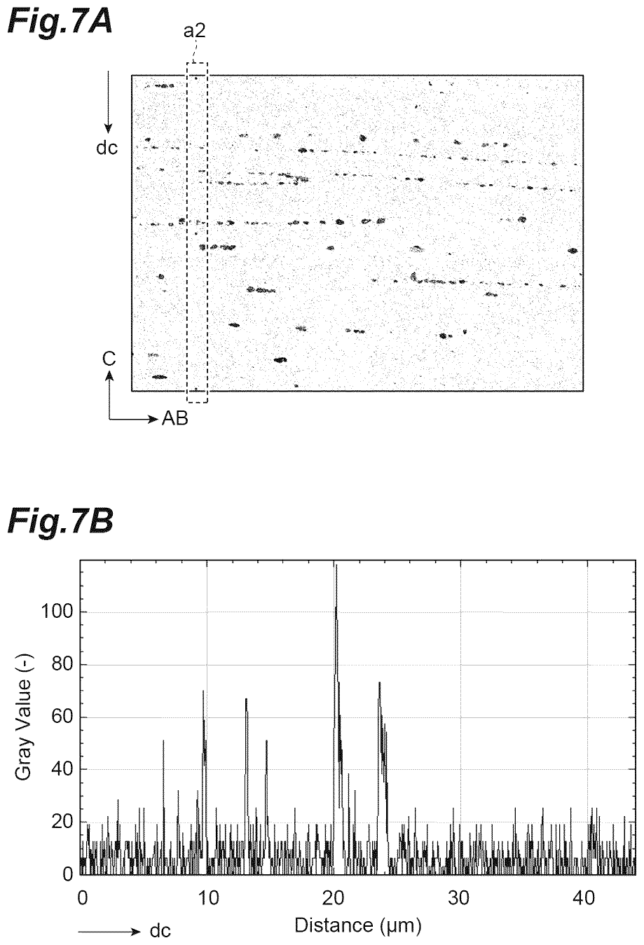

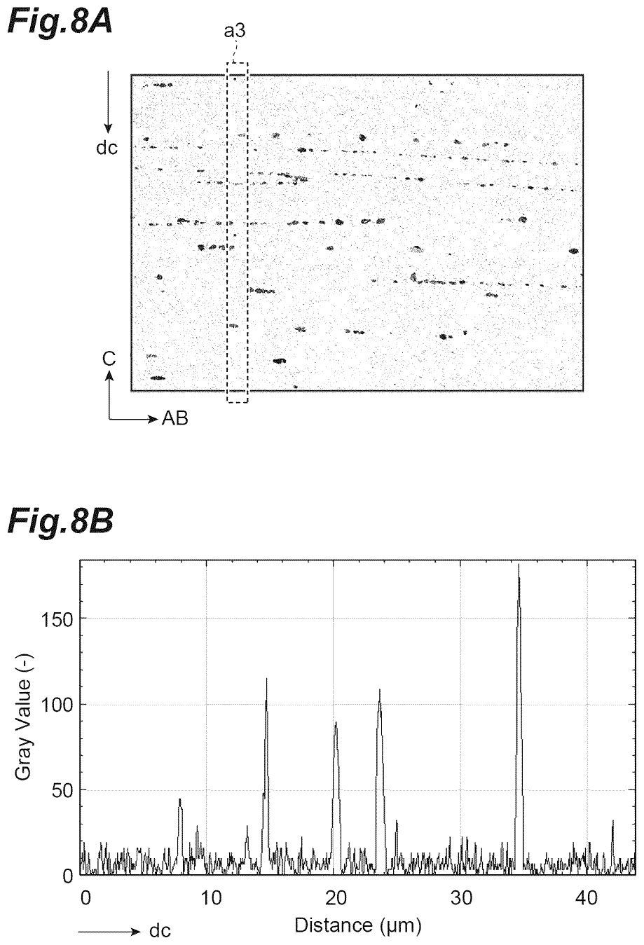

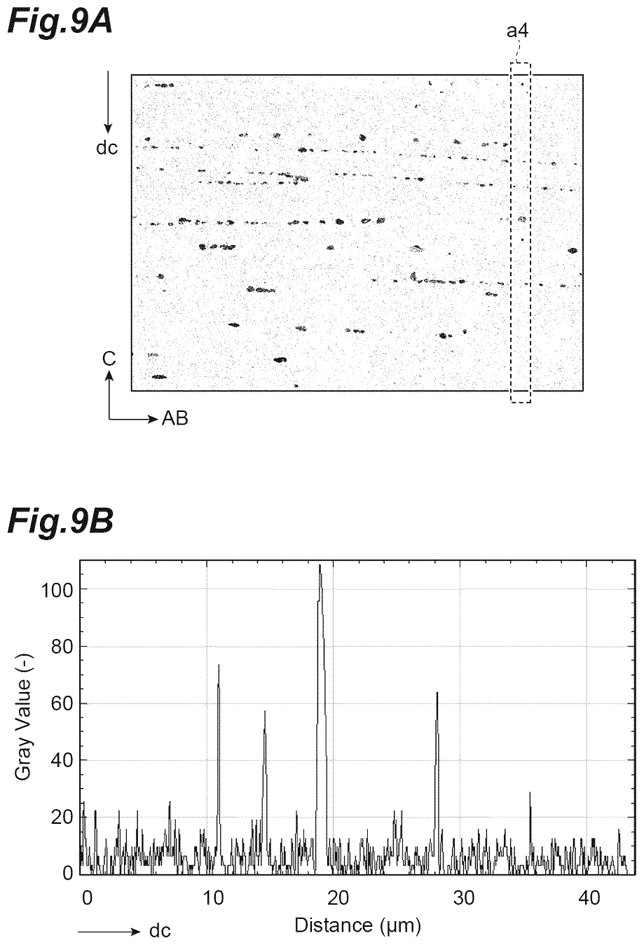

Monochrome images shown in FIG. 5B, FIG. 6A, FIG. 7A, FIG. 8A, and FIG. 9A are identical.

FIG. 6B is a distribution diagram of a gray value obtained by line scan along a scanning direction de in a measurement region a1 shown in FIG. 6A.

FIG. 7B is a distribution diagram of a gray value obtained by line scan along the scanning direction de in a measurement region a2 shown in FIG. 7A.

FIG. 8B is a distribution diagram of a gray value obtained by line scan along the scanning direction de in a measurement region a3 shown in FIG. 8A.

FIG. 9B is a distribution diagram of a gray value obtained by line scan along the scanning direction de in a measurement region a4 shown in FIG. 9A.

The scanning direction de is parallel to the easy magnetization axis direction C. The origin of the horizontal axis of each of FIG. 6B, FIG. 7B, FIG. 8B, and FIG. 9B is a starting point of the line scan. The horizontal axis of each of FIG. 6B, FIG. 7B, FIG. 8B, and FIG. 9B represents a distance (unit: μm) in the easy magnetization axis direction.

The gray value is a relative value depending on a binarization processing method, and a unit of the gray value is an arbitrary unit. An apex of a peak with a gray value of 50 or more is regarded as a position of the soft magnetic grain. Therefore, a distance between apexes of a pair of adjacent peaks is regarded as an interval of a pair of adjacent soft magnetic grains in the easy magnetization axis direction. In other words, the distance between the apexes of the pair of adjacent peaks is regarded as an interval of a pair of adjacent soft magnetic regions in the easy magnetization axis direction.

The interval of a plurality of soft magnetic regions in the easy magnetization axis direction (scanning direction dc) was measured at each of the measurement region a1, the measurement region a2, the measurement region a3, and the measurement region a4. Furthermore, the interval of a plurality of soft magnetic regions in the easy magnetization axis direction (scanning direction dc) was calculated at each of six measurement regions other than the measurement region a1, the measurement region a2, the measurement region a3, and the measurement region a4.

Any of the ten measurement regions was randomly selected from parts where a plurality of main phase grains and a plurality of soft magnetic regions are alternately arranged in the easy magnetization axis direction in the monochrome image shown in FIG. 5B. An average value Int_avg of the interval of the plurality of soft magnetic regions in the easy magnetization axis direction (scanning direction dc) was obtained by averaging intervals of the plurality of soft magnetic regions which were measured at the ten measurement regions. The average value Int_avg of the interval of the plurality of soft magnetic regions in Example 1 is shown in the following Table 1.

The measurement relating to the soft magnetic grains was carried out by ImageJ that is public domain imaging processing software.

An average value Ra_avg of the area fraction of a plurality of soft magnetic grains of each of Examples 2 to 11 and Comparative Examples 1 to 5 was calculated by the same method as in Example 1.

An average value Ws_avg of the width of a plurality of soft magnetic grains of each of Examples 2 to 11 and Comparative Examples 1 to 5 was calculated by the same method as in Example 1.

An average value Int_avg of the interval of a plurality of soft magnetic regions of each of Examples 2 to 11 and Comparative Examples 1 to 5 was calculated by the same method as in Example 1.

Ra_avg, Ws_avg, and Int_avg of each of Examples 2 to 11 and Comparative Examples 1 to 5 are shown in the following Table 1 and Table 2.

A thin piece was obtained by polishing the permanent magnet of Example 1 by a focused ion beam (FIB). A thickness of the thin piece was 100 nm. A composition of each of three soft magnetic grains (Grains 1 to 3) contained in the thin piece was analyzed. Grains 1 to 3 were aligned along the AB direction orthogonal to the easy magnetization axis direction C in one soft magnetic region. The composition of each of Grains 1 to 3 was analyzed by STEM-EDS. A concentration (unit: atomic %) of each element in each of Grains 1 to 3 is shown in the following Table 3. [T]/[R] of each of Grains 1 to 3 is also shown in the following Table 3. The inventor speculates that Cu detected from each soft magnetic grain is an impurity derived from the cooled roll. A soft magnetic grain in which [T]/[R] ranges from 8.4 to 8.8 was regarded as a soft magnetic grain containing an R-T phase. Definition of [T]/[R] is as described above. A soft magnetic grain in which [T]/[R] is 99.0 or more was regarded as a soft magnetic grain containing an α-Fe phase. Grain 1 and Grain 2 in Example 1 were soft magnetic grains containing the R-T phase. Grain 3 in Example 1 was a soft magnetic grain containing the α-Fe phase.

Compositions of the soft magnetic grains of each of Examples 2 to 11 and Comparative Examples 1 to 5 were analyzed by the same method as in Example 1.

In any of Examples 2 to 7 and Comparative Examples 1 to 5, both the soft magnetic grain containing the R-T phase and the soft magnetic grain containing the α-Fe phase were detected.

On the other hand, in any of Examples 8 to 11, the soft magnetic grain containing the α-Fe phase was detected, but the soft magnetic grain containing the R-T phase was not detected.

### (Measurement Relating to Main Phase Grain)

A back scattered electron image of a cross-section of the permanent magnet of each of Examples 1 to 11 and Comparative Examples 1 to 5 was taken by a SEM. The cross-section where the back scattered electron image was taken was parallel to the easy magnetization axis direction C. Dimensions of the back scattered electron image were 63.5 μm (length)×47.6 μm (width). Ten representative sites in the back scattered electron image were selected, and a back scattered electron image of each site was taken at a high magnification. Short-axis diameters (lengths of short axes) of main phase grains (primary grains) existing in the high-magnification back scattered electron image were measured. A shape of each main phase grain was approximated with a rectangle with the smallest area among rectangles circumscribing the main phase grain. A length of a short side of the rectangle was regarded as the short-axis diameter of the main phase grain. The Image J that is public domain image processing software was used for the approximation of the shape of each main phase grain. An average value Dm_avg of short-axis diameter of all main phase grains existing in the high-magnification back scattered electron image was calculated. Dm_avg of each of Examples 1 to 11 and Comparative Examples 1 to 5 is shown in the following Table 1 and Table 2.

### (Measurement of Magnetic Characteristics of Permanent Magnet)

A coercivity (HcJ), a residual magnetic flux density (Br), and a squareness ratio (Hk/HcJ) of the permanent magnet of each of Examples 1 to 11 and Comparative Examples 1 to 5 were measured. The coercivity, the residual magnetic flux density, and the squareness ratio were measured by a BH tracer. The coercivity was measured at 23° C. The residual magnetic flux density was measured at room temperature. The squareness ratio was measured at 23° C. Respective measurement values are shown in the following Table 1 and Table 2.

TABLE 1

| | Ribbon preparation step | | | Soft magnetic grain | | | Main phase | | | |
|---|---|---|---|---|---|---|---|---|---|---|
| | | | Cooled | (Soft magnetic reigon) | | | grain | | | |
| | Spraying | Nozzle | roll | | Area | | Short-axis | Magnetic | | |
| | differential | hole | circumferential | Interval | fraction | Width | diameter | characteristics | | |
| | pressure | diameter | speed | Int_avg | Ra_avg | Ws_avg | Dm_avg | HcJ | Br | Hk/HcJ |
| Unit | kPa | mm | m/sec | μm | % | μm | nm | kA/m | mT | % |
| Example 1 | 20.0 | 0.70 | 30.0 | 6.04 | 5.18 | 1.13 | 89.0 | 1206 | 1508 | 96.6 |
| Example 2 | 40.0 | 0.70 | 30.0 | 7.26 | 12.10 | 1.89 | 95.0 | 1103 | 1533 | 95.2 |
| Example 3 | 10.0 | 0.70 | 30.0 | 21.33 | 2.30 | 0.02 | 78.0 | 1190 | 1462 | 96.1 |
| Comparative | 50.0 | 0.70 | 30.0 | 3.96 | 11.30 | 5.89 | 112.0 | 998 | 1432 | 94.1 |
| Example 1 | | | | | | | | | | |
| Example 4 | 20.0 | 0.60 | 30.0 | 7.05 | 4.11 | 0.98 | 75.0 | 1270 | 1497 | 96.8 |
| Example 5 | 20.0 | 1.00 | 30.0 | 4.23 | 6.88 | 2.11 | 91.0 | 1112 | 1520 | 95.8 |
| Comparative | 20.0 | 1.30 | 30.0 | 3.25 | 11.80 | 5.21 | 103.0 | 811 | 1402 | 93.8 |
| Example 2 | | | | | | | | | | |
| Comparative | 20.0 | 0.70 | 20.0 | 4.03 | 15.60 | 5.32 | 95.0 | 1108 | 1478 | 94.2 |
| Example 3 | | | | | | | | | | |
| Comparative | 20.0 | 0.70 | 10.0 | 2.01 | 20.30 | 6.71 | 148.0 | 760 | 1348 | 93.4 |
| Example 4 | | | | | | | | | | |
| Example 6 | 20.0 | 0.70 | 40.0 | 9.89 | 3.48 | 0.52 | 71.0 | 1274 | 1467 | 95.5 |
| Example 7 | 20.0 | 0.70 | 60.0 | 12.17 | 1.13 | 0.03 | 67.0 | 1220 | 1447 | 95.6 |
| Comparative | 20.0 | 0.70 | 30.0 | 0.083 | 23.60 | 0.12 | 82.0 | 481 | 712 | 71.3 |
| Example 5 | | | | | | | | | | |

TABLE 2

| | Ribbon preparation step | | | Soft magnetic grain | | | Main phase | | | |
|---|---|---|---|---|---|---|---|---|---|---|
| | | | Cooled | (Soft magnetic region) | | | grain | | | |
| | Spraying | Nozzle | roll | | Area | | Short-axis | Magnetic | | |
| | differential | hole | circumferential | Interval | fraction | Width | diameter | characteristics | | |
| | pressure | diameter | speed | Int_avg | Ra_avg | Ws_avg | Dm_avg | HcJ | Br | Hk/HcJ |
| Unit | kPa | mm | m/sec | μm | % | μm | nm | kA/m | mT | % |
| Example 8 | 20.00 | 0.70 | 30.0 | 5.88 | 6.20 | 1.02 | 76.0 | 1473 | 1510 | 98.8 |
| Example 9 | 20.00 | 0.70 | 30.0 | 6.11 | 5.02 | 0.96 | 80.0 | 1403 | 1507 | 98.6 |
| Example 10 | 20.00 | 0.70 | 30.0 | 6.28 | 4.88 | 1.24 | 82.0 | 1337 | 1492 | 97.9 |
| Example 11 | 20.00 | 0.70 | 30.0 | 5.76 | 3.01 | 0.88 | 85.0 | 1277 | 1487 | 97.7 |

TABLE 3

| (atomic %) | Nd | Fe | Co | Cu | [T]/[R] |
|---|---|---|---|---|---|
| Grain 1 | 10.4 | 84.2 | 5.1 | 0.3 | 8.615385 |
| Grain 2 | 10.3 | 84.1 | 5.5 | 0.1 | 8.708738 |
| Grain 3 | 0.1 | 96.4 | 3.1 | 0.4 | 999 |

### INDUSTRIAL APPLICABILITY

For example, the R-T-B based permanent magnet according to an aspect of the present disclosure may be applied to a material of a motor mounted in electric vehicle or hybrid vehicles.

### REFERENCE SIGNS LIST

2: R-T-B based permanent magnet, 2cs: cross-section of R-T-B based permanent magnet (cross-section parallel to easy magnetization axis direction), 4: main phase grain, 6: soft magnetic grain, 8: sub-phase grain, sm: soft magnetic region.

What is claimed is:

1. An R-T-B based permanent magnet, containing:
a rare-earth element R;
a transition metal element T; and
boron,
wherein the R-T-B based permanent magnet contains at least Nd as the rare-earth element R,
the R-T-B based permanent magnet contains at least Fe as the transition metal element T,
the R-T-B based permanent magnet contains a plurality of main phase grains and a plurality of soft magnetic grains,
the plurality of main phase grains contain at least the rare-earth element R, the transition metal element T, and boron,
the plurality of soft magnetic grains contain at least Fe,
a cross-section of the R-T-B based permanent magnet includes a plurality of soft magnetic regions,
the cross-section of the R-T-B based permanent magnet is parallel to an easy magnetization axis direction of the R-T-B based permanent magnet,
each of the plurality of soft magnetic regions contains the plurality of soft magnetic grains aligned along a direction orthogonal to the easy magnetization axis direction,
the plurality of main phase grains and the plurality of soft magnetic regions are alternately disposed in the easy magnetization axis direction, and
an average value of width of the plurality of soft magnetic grains in the easy magnetization axis direction ranges from 20 nm to 5 μm.

2. The R-T-B based permanent magnet according to claim 1,
wherein an average value of intervals of the plurality of soft magnetic regions in the easy magnetization axis direction ranges from 4 μm to 15 μm.

3. The R-T-B based permanent magnet according to claim 1,
wherein an area fraction of the plurality of soft magnetic grains in the cross-section of the R-T-B based permanent magnet ranges from 4% to 15%.

4. The R-T-B based permanent magnet according to claim 1,
wherein at least a part of the plurality of soft magnetic grains contains an R-T phase containing the rare-earth element R and the transition metal element T.

5. The R-T-B based permanent magnet according to claim 1,
wherein a content of the rare-earth element R ranges from 26% by mass to 32% by mass, and
a content of boron ranges from 0.77% by mass to 1.15% by mass.

6. The R-T-B based permanent magnet according to claim 1,
wherein the plurality of main phase grains observed in the cross-section of the R-T-B based permanent magnet have platelet shapes.

7. The R-T-B based permanent magnet according to claim 1,
wherein widths of the plurality of main phase grains in the easy magnetization axis direction are smaller than widths of the plurality of the main phase grains in a direction orthogonal to the easy magnetization axis direction, and
an average value of the width of the plurality of main phase grains in the easy magnetization axis direction ranges from 20 nm to 200 nm.
